(19) United States
(12) Patent Application Publication
(10) Pub. No.: US 2026/0177733 A1
(43) Pub. Date: Jun. 25, 2026

(54) LAMINATE, VIRTUAL REALITY DISPLAY APPARATUS, AND MANUFACTURING METHOD OF LAMINATE

(71) Applicant: FUJIFILM Corporation, Tokyo (JP)

(72) Inventors: Rikako NAGAI, Minamiashigara-shi (JP); Naoya SHIBATA, Minamiashigara-shi (JP); Toshikazu SUMI, Minamiashigara-shi (JP); Koji NAGAHASHI, Minamiashigara-shi (JP)

(73) Assignee: FUJIFILM Corporation, Tokyo (JP)

(21) Appl. No.: 19/543,910

(22) Filed: Feb. 19, 2026

Related U.S. Application Data
(63) Continuation of application No. PCT/JP2024/031969, filed on Sep. 6, 2024.

(30) Foreign Application Priority Data
Sep. 28, 2023 (JP) 2023-166760

(51) Int. Cl. G02B 5/30; B32B 1/00; B32B 7/023; B32B 7/12; B32B 9/04; G02B 27/14

(52) U.S. Cl. CPC G02B 5/3016; B32B 1/00; B32B 7/023; B32B 7/12; B32B 9/045; G02B 27/144; B32B 2305/55; B32B 2307/42; B32B 2457/202

(57) ABSTRACT

The present invention can realize a virtual reality display apparatus in which a tint of a display image changes over time is suppressed, and provides a laminate, a virtual reality display apparatus, and a manufacturing method of a laminate, in which adhesiveness of a light absorption anisotropic layer is also excellent. The laminate according to the embodiment of the present invention includes, in the following order a substrate, a pressure-sensitive adhesion layer or an adhesion layer, and a light absorption anisotropic layer, in which the light absorption anisotropic layer contains a liquid crystal compound having smectic liquid crystallinity, the laminate has a curved surface shape portion, and the light absorption anisotropic layer in the curved surface shape portion satisfies a predetermined requirement.

### CROSS-REFERENCE TO RELATED APPLICATIONS

This application is a Continuation of PCT International Application No. PCT/JP2024/031969 filed on Sep. 6, 2024, which claims priority under 35 U.S.C. § 119(a) to Japanese Patent Application No. 2023-166760 filed on Sep. 28, 2023. The above applications are hereby expressly incorporated by reference, in their entirety, into the present application.

### BACKGROUND OF THE INVENTION

### 1. Field of the Invention

The present invention relates to a laminate, a virtual reality display apparatus, and a manufacturing method of a laminate.

### 2. Description of the Related Art

A virtual reality display apparatus is a display device which can provide a realistic effect as if entering a virtual world by wearing a dedicated headset on a head and visually recognizing a video displayed through a lens.

In the virtual reality display apparatus, a configuration called a pancake lens has been proposed, the lens configuration including an image display device, a reflective type polarizer, a half mirror, a retardation layer, and the like, in which the entire thickness of a headset is reduced by reciprocating rays emitted from the image display device between the reflective type polarizer and the half mirror.

In the pancake lens as described above, an absorptive polarizer is also used.

On the other hand, JP2019-194685A discloses a polarizer including a dichroic coloring agent and having a curved portion.

### SUMMARY OF THE INVENTION

The present inventors have produced a virtual reality display apparatus by using a polarizing plate having a curved portion disclosed in JP2019-194685A as an absorptive polarizer, and evaluated characteristics thereof, and as a result, found that a tint of a display image changes over time.

In addition, from the viewpoint of use in various applications, it is also required that the adhesiveness of the light absorption anisotropic layer is excellent.

In view of the above circumstances, an object of the present invention is to provide a laminate that can realize a virtual reality display apparatus in which a tint of a display image changes over time is suppressed and adhesiveness of a light absorption anisotropic layer is also excellent.

Another object of the present invention is to provide a virtual reality display apparatus and a manufacturing method of a laminate.

As a result of intensive studies repeatedly conducted by the present inventors on the above-described object, it has been found that the above-described object can be achieved by the following configurations.
(1) A laminate including, in the following order:
a substrate;
a pressure-sensitive adhesion layer or an adhesion layer; and
a light absorption anisotropic layer,
in which the light absorption anisotropic layer contains a liquid crystal compound having smectic liquid crystallinity,
the laminate has a curved surface shape portion, and
the light absorption anisotropic layer in the curved surface shape portion satisfies Requirement X described later.
(2) The laminate according to (1), in which the light absorption anisotropic layer in the curved surface shape portion satisfies Requirement Y described later.
(3) The laminate according to (1) or (2), in which the light absorption anisotropic layer contains a dichroic substance.
(4) The laminate according to (3), in which a concentration of the dichroic substance in the light absorption anisotropic layer is 180 mg/cm³ or less.
(5) The laminate according to (3) or (4), in which the dichroic substance includes at least two or more dichroic coloring agents having a maximal absorption wavelength of 550 nm or more.
(6) The laminate according to any one of (1) to (5), in which the light absorption anisotropic layer exhibits a Bragg peak in X-ray diffraction measurement.
(7) The laminate according to any one of (1) to (6), in which an in-plane variation in film thickness of the light absorption anisotropic layer in the curved surface shape portion is less than 7%.
(8) The laminate according to any one of (1) to (7), in which the light absorption anisotropic layer is a layer formed of a composition containing a dichroic substance and the liquid crystal compound.
(9) The laminate according to (8), in which the composition contains a thiol compound.
(10) The laminate according to (8) or (9), in which the composition contains a compound having an active hydrogen reactive group.
(11) The laminate according to any one of (1) to (10), further including an alignment film adjacent to the light absorption anisotropic layer.
(12) The laminate according to (11), in which the alignment film is a layer formed of a composition containing a compound having an active hydrogen reactive group.
(13) The laminate according to (12), in which the composition contains a polymer containing a structural unit having a photoreactive group and a structural unit having a polymerizable group.
(14) The laminate according to any one of (1) to (13), further including a phase difference layer, and a reflective linear polarizer.
(15) The laminate according to any one of (1) to (14), further including a cholesteric liquid crystal layer.
(16) The laminate according to any one of (1) to (15), further including a half mirror.
(17) A virtual reality display apparatus including the laminate according to any one of (1) to (16).
(18) A manufacturing method of the laminate according to any one of (1) to (16), including:
a step 1 of deforming, along a first forming surface, a planar precursor film including a light absorption anisotropic layer and a pressure-sensitive adhesion layer or an adhesion layer by using a forming die having the first forming surface, with a surface on a light absorption anisotropic layer side being on a first forming surface side; and
a step 2 of manufacturing the laminate by deforming, along a second forming surface, a precursor film that is obtained in the step 1 and on which a shape of the first forming surface is transferred, by using a substrate that has the second forming surface having a curvature radius smaller than a curvature radius of the first forming surface, with a surface on a side opposite to a surface in contact with the forming die of the first forming surface of the precursor film being on a side of the second forming surface,
in which the first forming surface has a concave shape and the second forming surface has a convex shape, or
the first forming surface has a convex shape and the second forming surface has a concave shape.
(19) The manufacturing method of the laminate according to any one of (1) to (16), including:
a step of manufacturing the laminate by providing a temperature distribution in an in-plane direction of a planar precursor film including a light absorption anisotropic layer and a pressure-sensitive adhesion layer or an adhesion layer, and by deforming, along a forming surface of a substrate, the precursor film, with a surface of the precursor film on a side opposite to a light absorption anisotropic layer side being on a forming surface side of the substrate that has a forming surface having a curved surface shape.

According to the present invention, it is possible to provide a laminate that can realize a virtual reality display apparatus in which a tint of a display image changes over time is suppressed and adhesiveness of a light absorption anisotropic layer is also excellent.

According to the present invention, it is also possible to provide a virtual reality display apparatus and a manufacturing method of a laminate.

### BRIEF DESCRIPTION OF THE DRAWINGS

FIG. 1 is a top view of an example of a laminate according to the embodiment of the present invention.

FIG. 2 is a cross-sectional view taken along a line A-A in FIG. 1.

FIG. 3 is a diagram for describing a measurement method using an integrating sphere.

FIG. 4 is a diagram for describing a measurement position of a film thickness of a light absorption anisotropic layer.

FIG. 5 is a view for describing a procedure for forming a film using a forming die having a concave forming surface.

FIG. 6 is a view for describing a procedure for forming a film using a forming die having a concave forming surface.

FIG. 7 is a top view of the film used for the forming.

FIG. 8 is a view for describing a procedure for forming a film using a forming die having a convex forming surface.

FIG. 9 is a view for describing a procedure for forming a film using a forming die having a convex forming surface.

FIG. 10 is a view for describing the method 1.

FIG. 11 is a view for describing the method 1.

FIG. 12 is a view for describing the method 1.

FIG. 13 is a view for describing a method 2.

FIG. 14 is a top view of a planar precursor film used in the method 2.

FIG. 15 is a cross-sectional view showing an example of a laminate according to the embodiment of the present invention.

FIG. 16 is a cross-sectional view showing another example of the laminate according to the embodiment of the present invention.

FIG. 17 is a diagram showing an example of a virtual reality display apparatus according to the embodiment of the present invention.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

Any numerical range expressed using “to” in the present specification refers to a range including the numerical values before and after the “to” as a lower limit value and an upper limit value, respectively.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In addition, in the present specification, Re(λ) and Rth(λ) respectively represent an in-plane direction retardation at a wavelength λ and a thickness-direction retardation at a wavelength λ. Unless otherwise specified, the wavelength λ is 550 nm.

In the present invention, Re(λ) and Rth(λ) are values measured at the wavelength of λ in AxoScan (manufactured by Axometrics, Inc.). By inputting the average refractive index ((nx+ny+nz)/3) and the film thickness (d) into the AxoScan,

Slow Axis Direction (°)

$$Re ( λ ) = R 0 ( λ ) , and$$

$$Rth ( λ ) = ( ( nx + ny ) / 2 - nz ) \times d$$

are calculated.

Although R0(λ) is displayed as a numerical value calculated by AxoScan, it means Re(λ).

In addition, in the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene 1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$nx > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

A feature point of the laminate according to the embodiment of the present invention is that the light absorption anisotropic layer in the curved surface shape portion satisfies Requirement X described later.

The present inventors have studied a cause of the tint of a display image changing over time in a case where a polarizing plate (corresponding to the light absorption anisotropic layer) having a curved surface shape portion, which is produced by the related art such as JP2019-194685A, is used as an absorptive polarizer to produce a virtual reality display apparatus. As a result, it was found that the cause is that the density of molecules is uneven in the polarizing plate in a case of forming the polarizing plate. For example, in a case where the degree of stretching varies depending on the position of the polarizing plate in a case of stretching the polarizing plate, the distance between molecules increases more in a portion where the stretching proceeds more, and the density of the molecules is likely to be lower, and as a result, a density nonuniformity of the molecules occurs. In a case where such a nonuniformity occurs, scattering occurs at an interface between dense and sparse portions.

In general, in a case where the polarizing plate is applied to the virtual reality display apparatus, various image processing and the like are performed such that a predetermined tint is observed according to the transmittance characteristics of the light absorption anisotropic layer. In such a case, in a case where the polarizing plate in which the nonuniformity is relaxed as described above is used, the action of gradually relaxing the nonuniformity over time proceeds, the transmittance characteristics of the polarizing plate change, and the tint changes from the initial tint under the conditions of various image processing set at the beginning, and as a result, the tint of the display image changes over time.

In the present invention, it has been found that the above-described object can be solved in a case where the light absorption anisotropic layer satisfying Requirement X is used. The requirement X is a requirement that a difference between a polarization degree measured without using an integrating sphere and a polarization degree measured using an integrating sphere is within a predetermined range, and the difference is small in a case where the density of the molecules is small in the light absorption anisotropic layer. The present inventors have found that the above-described object can be solved in a case where the light absorption anisotropic layer in which the difference indicated by Requirement X is within a predetermined range is used.

In addition, in the present invention, since the pressure-sensitive adhesion layer or the adhesion layer is disposed between the substrate and the light absorption anisotropic layer, the adhesiveness of the light absorption anisotropic layer (adhesiveness of the light absorption anisotropic layer to the substrate) is also excellent.

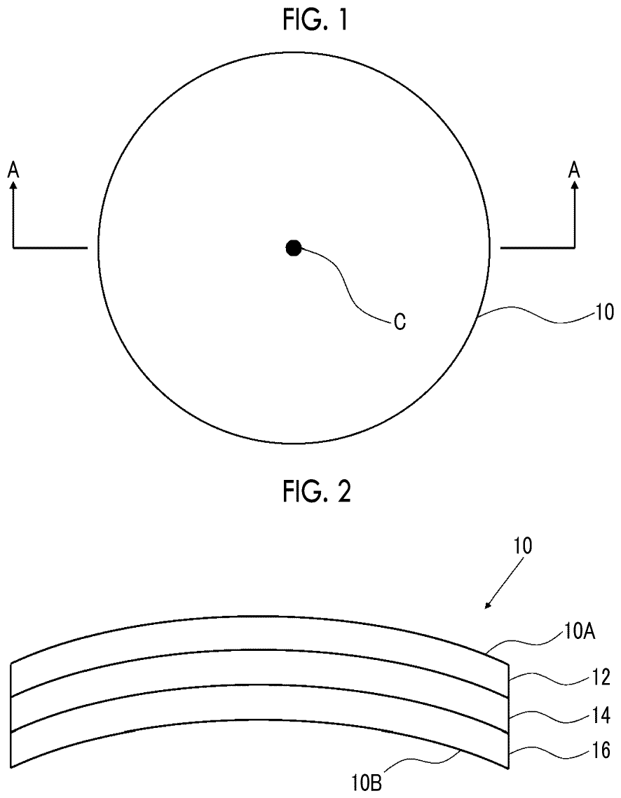

FIG. 1 shows an example of a laminate according to the embodiment of the present invention.

FIG. 1 is a top view of a laminate, and FIG. 2 is a cross-sectional view taken along line A-A of FIG. 1. The line A-A is a line passing through the center C of the laminate 10 which is circular in a plan view.

The laminate 10 includes a substrate 12, a pressure-sensitive adhesion layer 14, and a light absorption anisotropic layer 16 in this order.

As shown in FIGS. 1 and 2, the laminate 10 has a curved surface shape. More specifically, as shown in FIG. 2, the laminate 10 has a shape that is curved in a convex shape toward the upper side of the paper surface. That is, the laminate 10 has a convex shape protruding to one surface side. It is noted that the laminate 10 can also be said to have a recessed shape in which the other surface side is recessed.

In the laminate 10, the entire laminate 10 corresponds to the curved surface shape portion.

As shown in FIG. 2, the laminate 10 has two first surface 10A and second surface 10B facing each other, the first surface 10A is a curved surface convex toward the upper side of the paper surface, and the second surface 10B is a curved surface convex toward the upper side of the paper surface.

The curved surface shape of the laminate 10 shown in FIGS. 1 and 2 is a rotational parabolic surface shape, but may be a spherical surface shape or a rotational ellipsoid shape.

In addition, in FIGS. 1 and 2, the pressure-sensitive adhesion layer is used, but the adhesion layer may be used.

As shown in FIG. 1, in a case where the laminate 10 is observed from a normal direction of a tangent plane of the center C (corresponding to the apex of the protrusion) of the laminate 10 (in a case where the laminate 10 is viewed in a plan view), the shape of the laminate 10 is circular.

The center C of the laminate 10 is an intersection between an axis of the rotational ellipsoid shape and the laminate 10, and corresponds to a position where the center of the emission surface of the image display panel intersects with the normal line in a case where the laminate 10 is incorporated into a virtual reality display apparatus described later.

In a case where the laminate 10 is incorporated into a virtual reality display apparatus described below, the laminate 10 is disposed to be convex toward the image display panel side.

In a cross section of the laminate 10 in a plane including the normal line of the tangent plane of the center C of the laminate 10, a contour line (contour line corresponding to the first surface 10A of the laminate 10) on the outer side of the laminate 10 is a parabola.

In addition, in a case where the laminate 10 is cut in any plane parallel to the tangent plane of the center C of the laminate 10, the contour line on the outer side of the laminate 10 is circular.

In FIG. 1, an aspect in which the shape of the curved surface shape portion of the laminate is circular in a plan view has been described, but the present invention is not limited to this aspect, and the shape of the curved surface shape portion of the laminate in a plan view may be an elliptical shape or another shape.

The configuration of the curved surface shape portion of the laminate is not limited to the configuration of FIGS. 1 and 2.

The curved surface shape of the curved surface shape portion means a shape having a curvature of more than 0, and includes a developable curved surface shape and a three-dimensional curved surface shape. The developable surface is a surface which is developable onto a plane without stretching or contracting any part of the surface.

Examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface. The three-dimensional curved surface shape is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved surface shape may be a convex curved surface or a concave curved surface.

The curved surface shape is preferably lens-like. Examples of the lens-like curved surface shape include a spherical surface shape and a rotational ellipsoid shape; and the lens-like curved surface shape may be a convex lens-like shape or a concave lens-like shape.

As the curved surface shape portion of the laminate, a spherical surface shape, an rotational ellipsoid shape, or a rotational parabolic surface shape is preferable. That is, it is preferable that the curved surface shape portion is a spherical surface shape portion, a rotational ellipsoid shape portion, or a rotational parabolic surface shape portion.

The light absorption anisotropic layer in the curved surface shape portion of the laminate satisfies Requirement X.

Requirement X: in a case where a polarization degree of the light absorption anisotropic layer measured without using an integrating sphere is defined as a polarization degree P1, and a polarization degree of the light absorption anisotropic layer measured using an integrating sphere is defined as a polarization degree P2, the polarization degree P1 and the polarization degree P2 satisfy a relationship of Expression (1).

$$Polarization degree P 1 - Polarization degree P 2 \leq 0.27 \% \qquad Expression ( 1 )$$

Hereinafter, Requirement X will be described with reference to the drawings.

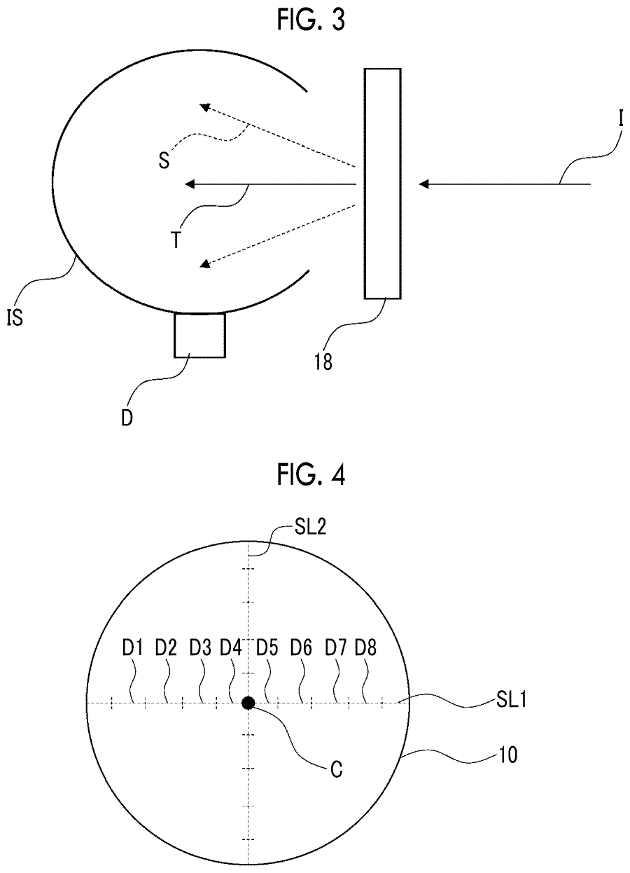

FIG. 3 shows a method of measuring the polarization degree in a case where a detector D including an integrating sphere IS is used. As shown in FIG. 3, in a case where incident light I that is traveling light is incident on a light absorption anisotropic layer 18 in a normal direction of a surface of the light absorption anisotropic layer 18, transmitted light T parallel to the incident light I indicated by a solid line and scattered light S indicated by a broken line are generated. In particular, as described above, in the light absorption anisotropic layer 18 in which the difference in density of the molecules is large, scattering is likely to occur at an interface between dense and sparse portions of the molecules, and the scattered light S is likely to be generated. In a case of the measurement using the integrating sphere, as shown in FIG. 3, not only the transmitted light T but also the scattered light S is detected. In a case where a large amount of the scattered light S is generated, the polarization degree P2 calculated by an expression described later is likely to be small. The reason why the polarization degree is likely to be small is that the transmittance in the absorption axis direction in Expression (2) described later is large.

On the other hand, in a case where a detector including no integrating sphere is used, as shown in FIG. 3, the scattered light S is not detected by the detector. That is, mainly, only the transmitted light T parallel to the incident light I is detected. In such a case, the transmittance in the absorption axis direction in Expression (2) described later is likely to be small, and as a result, the polarization degree P1 is likely to be large.

That is, the ease of generation of the scattered light S varies depending on the interface between the dense and sparse portions of the molecules, and the scattered light S is more likely to be generated as the number of the interfaces between the dense and sparse portions of the molecules increases, and in such a case, the polarization degree P2 is likely to be further small. As a result, the difference between the polarization degree P1 and the polarization degree P2 is further large. That is, the difference between the polarization degree P1 and the polarization degree P2 represents a degree of the number of interfaces between the dense and sparse portions in the sample, and the smaller the numerical value, the smaller the number of the interfaces between the dense and sparse portions. The smaller the numerical value, the less likely the relaxation due to the nonuniformity occurs, and as a result, the tint of the display image changes over time is suppressed in the virtual reality display apparatus in which the laminate according to the embodiment of the present invention is applied.

In the laminate according to the embodiment of the present invention, it is preferable that Requirement Y is satisfied from the viewpoint that the tint of the display image changes over time is further suppressed in the virtual reality display apparatus in which the laminate according to the embodiment of the present invention is applied.

Requirement Y: the polarization degree P1 and the polarization degree P2 satisfy a relationship of Expression (2).

$$Polarization degree P 1 - Polarization degree P 2 \leq 0.15 \% \qquad Expression ( 2 )$$

The lower limit of the difference (polarization degree P1−polarization degree P2) between the polarization degree P1 and the polarization degree P2 is not particularly limited, and examples thereof include 0%.

The magnitude of the polarization degree P1 is not particularly limited, but it is sufficient to satisfy the above-described requirement X, and it is preferably 70% to 100%, more preferably 80% to 99.9%, and still more preferably 95.0% to 99.9%.

As a method of calculating the polarization degree P1, light is incident from the normal direction of the surface of the light absorption anisotropic layer without using an integrating sphere, and the polarization degree is calculated. More specifically, linearly polarized light parallel to the transmission axis of the light absorption anisotropic layer is emitted from the normal direction of the surface of the light absorption anisotropic layer to measure a transmittance T1, linearly polarized light parallel to the absorption axis of the light absorption anisotropic layer is further emitted to measure a transmittance T2, and the polarization degree P1 is calculated from the following expression.

$$Polarization degree [ \% ] = [ ( T 1 - T 2 ) / ( T 1 + T 2 ) ] \times 100$$

T1: transmittance of the light absorption anisotropic layer with respect to polarization in the transmission axis direction

T2: transmittance of the light absorption anisotropic layer with respect to polarization in the absorption axis direction

The above-described measurement can be performed using an automatic polarization film measuring device (manufactured by JASCO Corporation, product name: VAP-7070).

The transmittance T1 and the transmittance T2 correspond to average transmittances obtained by correcting the measured values in a wavelength range of 380 to 780 nm with respect to the luminosity sensitivity. More specifically, the average transmittance is calculated by weighted-averaging the values of the transmittance obtained by the measurement at every 5 nm between 380 and 780 nm, using a Y value of a color matching function (CIE1931, a color matching function of a standard observer's color matching function, or the like) such as XYZ standardized by the International Commission on Illumination (CIE). That is, a calculated value A which is a product of the transmittance value measured at every 5 nm between 380 and 780 nm and the Y value corresponding to the measurement wavelength of the transmittance is calculated for every measurement wavelength, the calculated values A obtained at each measurement wavelength are summed to calculate a total value B, and further, the obtained total value B is divided by a total value C of the Y values used above (the total value B/the total value C) to calculate a transmittance.

In addition, in a case of calculating the polarization degree P2, the calculation is performed by the same procedure as in a case of calculating the polarization degree P1 using the detector including the integrating sphere.

A distance between the detector including the integrating sphere and the light absorption anisotropic layer as the measurement sample is preferably 5 mm.

In a case of measuring the polarization degree P1 and the polarization degree P2, only the light absorption anisotropic layer may be used as the sample, or a laminate including other members (for example, a support and a photo-alignment film) and the light absorption anisotropic layer may be used as the sample. In a case where the laminate including the other members and the light absorption anisotropic layer is used as the sample, the polarization degree P1 and the polarization degree P2 are calculated by excluding the influence of the other members on the polarization degree. For example, the polarization degree P1 and the polarization degree P2 may be calculated after confirming that the other members do not affect the polarization degree by irradiating the other members with light in advance.

The sample in a case of measuring the polarization degree P1 and the polarization degree P2 may be produced by cutting out a part of the curved surface shape portion in the laminate. In addition, a sample of the light absorption anisotropic layer having the same shape as the curved surface shape portion in the laminate may be separately produced and used as a sample for measurement.

A curvature radius of the curved surface shape portion of the laminate is not particularly limited, but from the viewpoint of further suppressing the occurrence of ghost in a case where the laminate is applied to the virtual reality display apparatus, it is preferably 20 to 80 mm, more preferably 30 to 80 mm, and still more preferably 35 to 60 mm.

The curvature radius of the curved surface shape portion may be constant at any position of the curved surface shape portion or may be different at any position, and it is preferable that the curvature radius at any position is within the above-described range. In a case where the curvature radius is constant at any position of the curved surface shape portion, the shape of the curved surface shape portion corresponds to a spherical surface shape.

A minimum curvature radius of the curved surface shape portion is not particularly limited, but from the viewpoint of further suppressing the occurrence of ghost in a case where the laminate is applied to the virtual reality display apparatus, it is preferably 30 to 80 mm and more preferably 35 to 60 mm.

A maximum curvature radius of the curved surface shape portion is not particularly limited, but from the viewpoint of further suppressing the occurrence of ghost in a case where the laminate is applied to the virtual reality display apparatus, it is preferably 35 to 80 mm and more preferably 35 to 60 mm.

In a case where the curved surface shape of the curved surface shape portion is a spherical shape, an rotational ellipsoidal shape, or a rotational parabolic surface shape portion, a size of the curved surface shape portion in a plan view of the curved surface shape portion of the laminate from the rotation axis direction of these shapes is not particularly limited, and an equivalent circle diameter of the curved surface shape portion is preferably 30 to 80 mm and more preferably 40 to 60 mm.

The equivalent circle diameter is a diameter of a virtual perfect circle assumed to have the same projected area as the projected area of the curved surface shape portion observed.

A film thickness of the curved surface shape portion is not particularly limited, but from the viewpoint of more excellent effects of the present invention, it is preferably 0.5 to 5.0 m and more preferably 1.0 to 3.0 m.

The film thickness means an average value of film thicknesses obtained in a case of calculating the in-plane variation in film thickness of the light absorption anisotropic layer of the curved surface shape portion described above.

The in-plane variation in film thickness of the light absorption anisotropic layer in the curved surface shape portion of the laminate according to the embodiment of the present invention is not particularly limited, but from the viewpoint of further suppressing the occurrence of ghost in a case where the laminate is applied to the virtual reality display apparatus, it is preferably 7% or less and more preferably 4% or less. The lower limit thereof is not particularly limited, and examples thereof include 0%, which is often 0.1% or more.

Examples of a method of measuring the in-plane variation in film thickness of the light absorption anisotropic layer in the curved surface shape portion include a method according to the following procedure.

First, the laminate is cut with a microtome to expose a cross section, and the cross section is observed with a scanning electron microscope (SEM) at an appropriate magnification (20,000 to 50,000 times) to obtain the film thickness of the light absorption anisotropic layer in the curved surface shape portion.

In order to easily observe the cross section, the measurement sample may be subjected to appropriate treatment such as carbon vapor deposition and etching. An acceleration voltage is preferably optimized under a condition of 1 to 10 kV

A position at which the film thickness of the light absorption anisotropic layer in the curved surface shape portion is measured is determined by the following method. Hereinafter, the laminate 10 shown in FIGS. 1 and 2 will be described as an example.

First, the laminate is viewed in a plan view from the normal direction of the emission surface of the image display panel in a case where the laminate is applied to the virtual reality display apparatus, and an intersection between an axis extending in the normal direction through the center of the emission surface and the laminate in a plan view is defined as the center of the curved surface shape portion. As shown in FIG. 4, in a case of the laminate 10, the center C of the laminate 10 corresponds to the center of the curved surface shape portion.

Next, in a projection image obtained by viewing the curved surface shape portion in a plan view, a straight line which passes through the above-described center and extends in one in-plane direction is referred to as a first straight line, and a straight line which is orthogonal to the first straight line and extends in the in-plane direction is referred to as a second straight line. In FIG. 4, a straight line passing through the center C and extending in the left-right direction of the paper plane is referred to as a first straight line SL1, and a straight line extending orthogonal to the straight line SL1 is referred to as a second straight line SL2. In FIG. 4, a line extending in the left-right direction of the paper plane and a line extending in the up-down direction are set as the first straight line and the second straight line, but the present invention is not limited to the aspect, and any straight line extending in one in-plane direction can be employed as the first straight line.

Next, the first straight line and the second straight line positioned within the region of the curved surface shape portion in the plan view (within the region of the projection image) are each divided into 10 parts. As shown in FIG. 4, the first straight line SL1 and the second straight line SL2 indicated by the broken line are divided into 10 regions of equal length. Among the obtained 10 parting lines, 8 parting lines excluding parting lines located at both ends are selected, and the film thickness at the position of the optically anisotropic layer corresponding to any position on each parting line is obtained from the above-described SEM observation image. More specifically, as shown in FIG. 4, the first straight line SL1 is divided into 10 parts, 8 parting lines (D1 to D8) excluding parting lines located at both ends are obtained, the position of any one point on each parting line is selected, and the film thickness of the optically anisotropic layer at the position corresponding to the selected position is calculated. The position of the optically anisotropic layer corresponding to any position on the division line corresponds to an intersection between an axis extending in the normal direction of the projection image in which the division line is described through the selected position on the division line described in the projection image obtained by viewing the laminate in a plan view and the optically anisotropic layer. That is, the position on the parting line in the projection image is reflected on the position of the optically anisotropic layer, and the film thickness at the position of the optically anisotropic layer (the film thickness in the normal direction of the tangent plane at the position) is calculated. The film thicknesses of the optically anisotropic layers at the eight positions can be calculated according to the above-described procedure.

For the second straight line as well, the film thicknesses of the optically anisotropic layers at the eight positions can be calculated according to the same procedure as described above.

Using the obtained values of the film thicknesses at the 16 positions, an average value of the values, the maximum value of the values, and the minimum value of the values are calculated. Next, among the difference between the maximum value and the average value and the difference between the minimum value and the average value, a larger difference (hereinafter, also referred to as “specific difference”) is selected, and a proportion of the obtained difference to the average value [(Specific difference/Average value)×100] is calculated.

The light absorption anisotropic layer in the laminate according to the embodiment of the present invention preferably has an ordered structure derived from a crystal phase or a higher-order liquid crystal phase from the viewpoint of the alignment degree. The presence of the ordered structure can be confirmed by performing X-ray diffraction measurement using the light absorption anisotropic layer as a sample, and observing a crystalline Bragg peak (peak derived from Bragg reflection) by X-ray diffraction.

The above-described Bragg peak is a peak derived from a molecular alignment plane periodic structure, and a period interval thereof is preferably 3.0 to 5.0 Å.

In addition, a single plate transmittance of the light absorption anisotropic layer is preferably 40% or more, and more preferably 42% or more. The upper limit thereof is not particularly limited, but may be 60% or less.

In addition, a polarization degree of the light absorption anisotropic layer is preferably 90% or more, more preferably 95% or more, and still more preferably 99% or more. The upper limit thereof is not particularly limited, but may be less than 100%.

In the light absorption anisotropic layer, the single plate transmittance and the polarization degree of the linear polarizer are measured using an automatic polarizing film measuring device: VAP-7070 (manufactured by Jasco Corporation).

Hereinafter, members constituting the present invention will be described in detail.

### [Substrate]

The substrate is a member that supports the light absorption anisotropic layer described later.

The type of the substrate is not particularly limited, but a lens is preferable.

Examples of the lens include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display apparatus, a convex meniscus lens or a concave meniscus lens is preferable from the viewpoint of enlarging the angle of view, and a concave meniscus lens is more preferable from the viewpoint that chromatic aberration can be further suppressed.

As a material of the substrate (lens), a material transparent to visible light, such as glass, crystal, or plastic, can be used. Since the birefringence of the lens causes rainbow-like unevenness or light leakage, it is preferable that the birefringence is small, and a material having zero birefringence is more preferable.

In addition, a curvature radius of the substrate (lens) is not particularly limited, but from the viewpoint of more excellent effects of the present invention, it is preferably 20 to 80 mm, more preferably 30 to 80 mm, and still more preferably 35 to 60 mm.

### [Pressure-Sensitive Adhesion Layer or Adhesion Layer]

As the pressure-sensitive adhesion layer or the adhesion layer (hereinafter, these are also collectively referred to as an “intimate attachment layer”), a known layer can be used.

The pressure-sensitive adhesion layer is formed of a known pressure sensitive adhesive. Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive; and among these, an acrylic pressure sensitive adhesive is preferable.

The adhesion layer is formed of a known adhesive. Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet curable adhesive, and a visible light-curable adhesive; and among these, an ultraviolet curable adhesive is preferable.

It is preferable that the intimate attachment layer is disposed to be in contact with the substrate.

A plurality of intimate attachment layers may be included in the laminate. For example, a plurality of intimate attachment layers may be included between the substrate and the light absorption anisotropic layer.

A thickness of the intimate attachment layer is not particularly limited, but from the viewpoint of thinning, it is preferably 25 m or less, more preferably 15 m or less, and still more preferably 5 m or less. The lower limit thereof is not particularly limited, but is 0.1 μm or more in many cases.

### [Light Absorption Anisotropic Layer]

The light absorption anisotropic layer contains a liquid crystal compound having smectic liquid crystallinity.

The liquid crystal compound having smectic liquid crystallinity refers to a compound capable of exhibiting a liquid crystal state of a smectic phase. Further, the smectic phase means that molecules aligned in one direction have a layer structure.

The fact that the liquid crystal compound has smectic liquid crystallinity can be confirmed, for example, by observing a unique organization of the smectic phase by an observation using an optical microscope.

The liquid crystal compound may be immobilized in the light absorption anisotropic layer. For example, in a case where the light absorption anisotropic layer is formed of a polymerizable liquid crystal compound, the liquid crystal compound may be immobilized by polymerization through a polymerizable group.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound.

Here, the “high-molecular-weight liquid crystal compound” refers to a liquid crystal compound having a repeating unit in the chemical structure.

In addition, “low-molecular-weight liquid crystal compound” refers to a liquid crystal compound not including a repeating unit in a chemical structure.

The content of the liquid crystal compound in the light absorption anisotropic layer is preferably in a range of 25 to 2000 parts by mass, more preferably in a range of 100 to 1300 parts by mass, and still more preferably in a range of 200 to 900 parts by mass with respect to 100 parts by mass of the content of the dichroic substances. In a case where the content of the liquid crystal compound is within the above-described range, the alignment degree of the dichroic substance is further improved.

The liquid crystal compound may be contained only one kind or two or more kinds. In a case of containing two or more kinds of liquid crystal compounds, the above-described content of the liquid crystal compound means the total content of the liquid crystal compounds.

It is preferable that the aligned liquid crystal compound is immobilized in the light absorption anisotropic layer. Among these, in the light absorption anisotropic layer, it is more preferable that the liquid crystal compound homogeneously aligned is immobilized.

It is preferable that the dichroic substance in the light absorption anisotropic layer is aligned in a specific direction. Among these, in the light absorption anisotropic layer, it is more preferable that the dichroic substance is aligned in one in-plane direction. In particular, it is still more preferable that the dichroic substance is also aligned in the liquid crystal compound which is homogeneously aligned.

As will be described later, the light absorption anisotropic layer is preferably a layer formed of a composition (a composition for forming a light absorption anisotropic layer) containing the liquid crystal compound and a dichroic substance described later. Among these, it is more preferable that the light absorption anisotropic layer is a layer obtained by curing a composition containing a liquid crystal compound having a polymerizable group and a dichroic substance.

It is preferable that the light absorption anisotropic layer contains a cured product of the liquid crystal compound containing a polymerizable group.

### <Dichroic Substance>

The dichroic substance means a substance having different absorbances depending on directions. The dichroic substance may be immobilized in the light absorption anisotropic layer.

The dichroic substance is a substance exhibiting dichroism, and the dichroism denotes a property in which an absorbance varies depending on the polarization direction.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (preferably, dichroic coloring agents) of the related art can be used.

As the dichroic substance, a dichroic azo coloring agent compound is preferable.

The dichroic azo coloring agent compound denotes an azo coloring agent compound having different absorbances depending on the direction. The dichroic azo coloring agent compound may or may not exhibit liquid crystallinity. In a case where the dichroic azo coloring agent compound exhibits liquid crystallinity, any of nematic properties or smectic properties may be exhibited. A temperature range at which the liquid crystal phase is exhibited is preferably room temperature (approximately 20° C. to 28° C.) to 300° C., and from the viewpoint of handleability and manufacturing suitability, more preferably 50° C. to 200° C.

The dichroic substance preferably includes a dichroic coloring agent having a maximal absorption wavelength of 550 nm or more, and more preferably includes two or more dichroic coloring agents having a maximal absorption wavelength of 550 nm or more.

In addition, from the viewpoint of adjusting the tint, it is preferable to use at least one coloring agent compound having a maximal absorption wavelength in a wavelength range of 560 to 700 nm (hereinafter, also abbreviated as a “first dichroic coloring agent compound”) and at least one coloring agent compound having a maximal absorption wavelength in a wavelength range of 455 nm or more and less than 560 nm (hereinafter, also abbreviated as a “second dichroic coloring agent compound”).

In the present invention, three or more kinds of dichroic coloring agent compounds may be used in combination. For example, from the viewpoint of approximating the light absorption anisotropic layer to black, it is preferable that the first dichroic coloring agent compound, the second dichroic coloring agent compound, and at least one coloring agent compound having a maximal absorption wavelength in a wavelength range of 380 nm or more and less than 455 nm are used in combination.

Examples of the dichroic substance which can be used in the present invention include those described in WO2018/186503A, WO2019/189345A, and WO2018/124198A.

The content of the dichroic substance is preferably in a range of 1% to 30% by mass, more preferably in a range of 5% to 25% by mass, and still more preferably in a range of 10% to 20% by mass with respect to the total mass of the solid content of the light absorption anisotropic layer.

From the viewpoint of increasing the alignment degree, a concentration of the dichroic substance in the light absorption anisotropic layer is preferably 180 mg/cm³ or less and more preferably 150 mg/cm³ or less. The lower limit thereof is not particularly limited, but is preferably 20 mg/cm³ or more and more preferably 40 mg/cm³ or more.

### <Other Components>

The light absorption anisotropic layer may contain an adhesion improver, a plasticizer, a polymer, and the like, in addition to the above-described components.

Here, examples of the adhesion improver include reactive additives described in paragraphs [0123] to [0129] of JP2019-091088A and boronic acid monomers described in paragraphs [0015] to [0028] of WO2015/053359A.

### [Manufacturing Method of Laminate]

The manufacturing method of a laminate according to the embodiment of the present invention is not particularly limited as long as the laminate having the above-described characteristics can be manufactured.

For example, a manufacturing method of a laminate including a light absorption anisotropic layer and a pressure-sensitive adhesion layer or an adhesion layer, manufacturing a planar precursor film, and forming the planar precursor film to manufacture a laminate having a curved surface shape portion can be used.

Examples of the method of forming the laminate include a method of forming the planar precursor film in two stages (Method 1) and a method of heating the planar precursor film with a distribution of heating temperature in an in-plane direction during the forming to form the laminate (Method 2).

Hereinafter, first, a method of manufacturing a planar precursor film will be described, and then the methods 1 and 2 will be described in detail. In the following description of the methods 1 and 2, as an example, a procedure in a case of obtaining the laminate 10 shown in FIGS. 1 and 2 will be described in detail.

### <Manufacturing Method of Planar Light Absorption Anisotropic Layer>

The manufacturing method of the planar light absorption anisotropic layer is not particularly limited, and examples thereof include known methods. Among these, a method of manufacturing a planar light absorption anisotropic layer using a composition (a composition for forming a light absorption anisotropic layer) containing a dichroic substance and a liquid crystal compound is preferable.

More specific examples thereof include a method including, in the following order, a step of applying a composition for forming a light absorption anisotropic layer onto a planar support to form a coating film (hereinafter, also referred to as “coating film forming step”) and a step of aligning a liquid crystalline component or the dichroic substance, contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### —Coating Film Forming Step—

The coating film forming step is a step of applying a composition for forming a light absorption anisotropic layer onto a planar support to form a coating film.

The composition for forming a light absorption anisotropic layer contains the dichroic substance and the liquid crystal compound described above. The dichroic substance and the liquid crystal compound contained in the composition for forming a light absorption anisotropic layer may have a polymerizable group. As the polymerizable group, an acryloyl group, a methacryloyl group, an epoxy group, an oxetanyl group, or a styryl group is preferable; and an acryloyl group or a methacryloyl group is more preferable. In a case where the dichroic substance and the liquid crystal compound have a polymerizable group, these compounds can be immobilized in the light absorption anisotropic layer in a curing step described later.

The composition for forming a light absorption anisotropic layer may contain a thiol compound.

The thiol compound is a compound having a thiol group (HS group). The number of thiol groups contained in the thiol compound is not particularly limited, and is preferably 1 to 10 and more preferably 2 to 4.

As the thiol compound, a compound represented by Formula X is preferable.

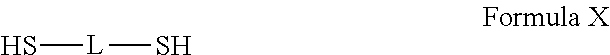

L includes a divalent aliphatic hydrocarbon group which may include a group selected from the group consisting of —CO—O—, —CO—, and —O—.

The number of carbon atoms of the divalent aliphatic hydrocarbon group is preferably 1 to 10 and more preferably 2 to 8.

A content of the thiol compound in the composition for forming a light absorption anisotropic layer is not particularly limited, but is preferably 0.1 to 10 parts by mass and more preferably 0.5 to 6 parts by mass with respect to 100 parts by mass of the liquid crystal compound.

The composition for forming a light absorption anisotropic layer may contain a compound having an active hydrogen reactive group. In the present specification, the “active hydrogen reactive group” means a group having reactivity with a group having active hydrogen such as a carboxyl group (—COOH), a hydroxyl group (—OH), an amino group (—NH₂), and a mercapto group (—SH).

Examples of an active hydrogen reactive group include an epoxy group, a glycidyl group, an oxazoline group, a carbodiimide group, an aziridine group, an imide group, an alkoxysilyl group, an isocyanate group, a thioisocyanate group, and a maleic anhydride group.

The above-described compound preferably has at least one group selected from the group consisting of an epoxy group, a glycidyl group, an isocyanate group, and an alkoxysilyl group, more preferably has an isocyanate group or an alkoxysilyl group, and still more preferably has an isocyanate group.

The number of active hydrogen reactive groups is preferably 1 to 20 and more preferably 1 to 10. In a case where a plurality of active hydrogen reactive groups are present, the plurality of active hydrogen reactive groups that are present may be the same or different from each other.

The above-described compound preferably further has a polymerizable group in addition to the active hydrogen reactive group. The polymerizable group may be, for example, a carbon-carbon unsaturated bond such as a carbon-carbon double bond or a carbon-carbon triple bond, and specific examples thereof include a vinyl group, a vinyl oxy group, a 1-chlorovinyl group, an isopropenyl group, a 4-vinylphenyl group, a (meth)acryloyl group, an oxiranyl group, and an oxetanyl group, where a (meth)acryloyl group is preferable.

The number of polymerizable groups is preferably 1 to 20 and more preferably 1 to 10.

As the above-described compound, a commercially available product may be used. Examples of such a commercially available product include Laromer (registered trademark) PR9000 (manufactured by BASF SE), Karenz AOI (registered trademark) (manufactured by SHOWA DENKO K.K.), Karenz BEI (registered trademark) (manufactured by SHOWA DENKO K.K.), Karenz MOI-EG (registered trademark) (manufactured by SHOWA DENKO K.K.), and KBM-5103 (manufactured by Shin-Etsu Chemical Co., Ltd.).

A content of the compound having an active hydrogen reactive group in the composition for forming a light absorption anisotropic layer is preferably 0.1 to 12 parts by mass and more preferably 0.5 to 10 parts by mass with respect to 100 parts by mass of the liquid crystal compound.

The support used in the present step is not particularly limited, and a known planar support can be used.

In addition, an alignment film may be provided on the support as necessary. By providing the alignment film, the liquid crystalline component can be aligned. Examples of the alignment film include a photo-alignment film.

In the present step, the composition for forming a light absorption anisotropic layer can be easily applied by using a composition for forming a light absorption anisotropic layer, which contains a solvent, or using a liquid such as a melt obtained by heating the composition for forming a light absorption anisotropic layer.

Examples of the method of applying the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

### —Alignment Step—

The alignment step is a step of aligning the liquid crystalline component contained in the coating film. As a result, a planar light absorption anisotropic layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light absorption anisotropic layer may be aligned by the coating film forming step or the drying treatment described above. For example, in an aspect in which the composition for forming a light absorption anisotropic layer is prepared as a coating liquid containing a solvent, a coating film having light absorption anisotropy is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. As a result, since the liquid crystalline component in the coating film can be aligned, the heated coating film can be suitably used as the light absorption anisotropic layer.

From the viewpoint of manufacturing suitability, a heating temperature is preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### —Other Steps—

The method of forming the planar light absorption anisotropic layer may include a step of curing the light absorption anisotropic layer after the above-described alignment step (hereinafter, also referred to as “curing step”).

For example, in a case where the compound in the light absorption anisotropic layer has a polymerizable group, the curing step is performed by heating and/or light irradiation (exposure). Among these, from the viewpoint of productivity, it is preferable that the curing step is performed by irradiating the light absorption anisotropic layer with light.

Various light sources such as infrared rays, visible light, and ultraviolet rays can be used as a light source for the curing, but ultraviolet rays are preferable. In addition, ultraviolet rays may be applied while the layer is heated during curing, or ultraviolet rays may be applied through a filter that transmits only a specific wavelength.

In a case where the exposure is performed while the light absorption anisotropic layer is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

### <Manufacturing Method of Precursor Film>

The manufacturing method of a planar precursor film is not particularly limited, and examples thereof include a method of directly or via another layer disposing a intimate attachment layer on the planar light absorption anisotropic layer produced by the above-described method.

More specifically, a method of disposing a intimate attachment layer on a surface of a laminate including a support and a planar light absorption anisotropic layer can be used. Examples of the method of disposing the intimate attachment layer include a method of transferring the intimate attachment layer disposed on the temporary support.

### <Method 1>

A method 1 is a method of forming the planar precursor film in two stages.

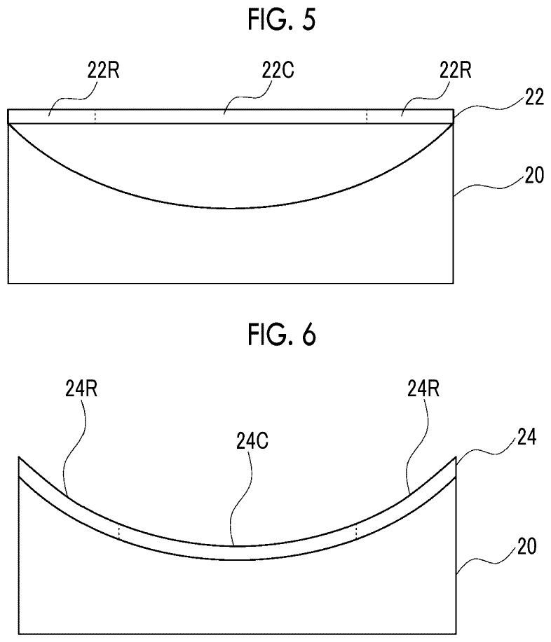

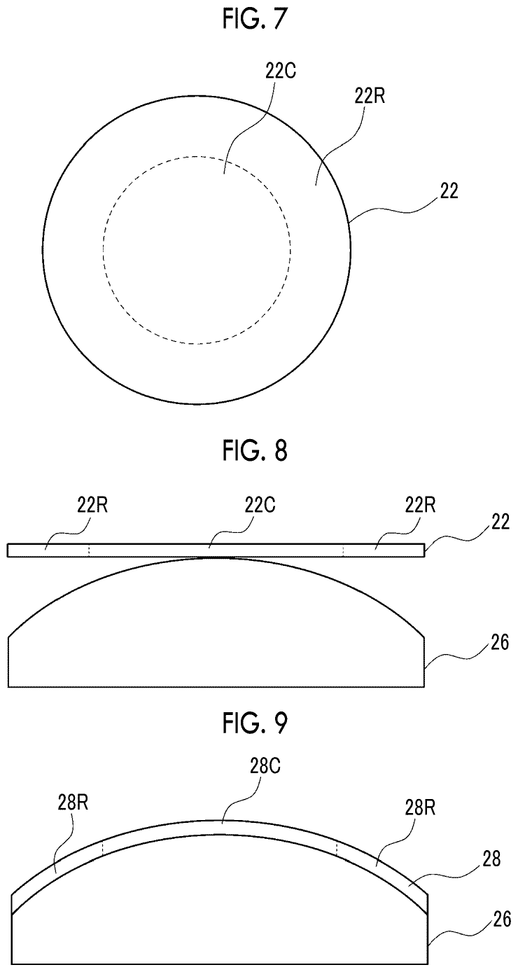

First, a phenomenon occurring in a case of forming a film using a typical forming die having a concave forming surface will be described with reference to FIGS. 5 to 7. FIGS. 5 and 6 show a procedure for forming a film using a forming die having a concave forming surface, and FIG. 7 shows the film used for the forming.

As shown in FIG. 5, a circular film 22 is placed on a forming die 20 having a concave forming surface, and as shown in FIG. 6, the film 22 is deformed along a forming surface of the forming die 20, whereby a film 24 with the concave surface shape transferred is obtained.

Usually, in a case of forming with the concave surface, a difference in stretching ratio occurs in a center portion 22C and a periphery portion 22R surrounding the center portion 22C of the film 22, as shown in FIGS. 5 and 7. More specifically, the center portion 22C of the film 22 is more easily stretched than the periphery portion 22R of the film 22. As a result, in the film 24 in which the concave surface shape is transferred, in the center portion 24C, the interval between the molecules is likely to be wider than that in the periphery portion 24R.

Next, a phenomenon occurring in a case of forming a film using a forming die having a convex forming surface will be described with reference to FIGS. 7 to 9. FIGS. 8 and 9 show a procedure for forming a film using a forming die having a convex forming surface, and FIG. 7 shows the film used for the forming.

As shown in FIG. 8, a circular film 22 is placed on a forming die 26 having a convex forming surface, and as shown in FIG. 9, the film 22 is deformed along a forming surface of the forming die 26, whereby a film 28 with the convex surface shape transferred is obtained.

Usually, in a case of forming with the convex surface, a difference in stretching ratio occurs in a center portion 22C and a periphery portion 22R of the film 22, as shown in FIGS. 7 and 8. More specifically, the periphery portion 22R of the film 22 is more easily stretched than the center portion 22C of the film 22. As a result, in the film 28 in which the convex surface shape is transferred, in the periphery portion 28R, the interval between the molecules is likely to be wider than that in the center portion 28C.

As described above, in a case of forming a concave surface, the center portion of the obtained film is likely to be stretched more than the periphery portion, and the interval between the molecules in the center portion is likely to be widened, and as a result, a difference in density of the arrangement state of the molecules is likely to occur between the center portion and the periphery portion. In addition, in a case of forming a convex surface, the periphery portion of the obtained film is likely to be stretched more than the center portion, and the interval between the molecules in the periphery portion is likely to be widened, and as a result, a difference in density of the arrangement state of the molecules is likely to occur between the center portion and the periphery portion.

As described above, in a general forming method, a difference is likely to occur between the interval between the molecules in the center portion of the film to be formed and the interval between the molecules in the periphery portion, and scattering and the like are likely to occur at an interface between regions having such different states, and as a result, the difference between the polarization degree P1 and the polarization degree P2 is large.

Therefore, as a first aspect of the method 1, a manufacturing method including a step 1A of deforming a planar precursor film including a light absorption anisotropic layer and a intimate attachment layer, with a surface of the light absorption anisotropic layer side being on a convex forming surface side, along a convex forming surface using a forming die having a convex surface shape, and a step 2A of deforming a precursor film, in which a convex surface shape obtained in the step 1A is transferred, with a surface opposite to a surface in contact with the forming die in the step 1A on the forming surface side of the substrate having a concave forming surface having a curvature radius smaller than a curvature radius of the convex forming surface, along the concave forming surface, to manufacture the laminate can be used.

In addition, as a second aspect of the method 1, a manufacturing method including a step 1B of deforming a planar precursor film including a light absorption anisotropic layer and a intimate attachment layer, with a surface of the light absorption anisotropic layer side being on a concave forming surface side, along a concave forming surface using a forming die having a concave surface shape, and a step 2B of deforming a precursor film, in which a concave surface shape obtained in the step 1B is transferred, with a surface opposite to a surface in contact with the forming die in the step 1B on the forming surface side of the substrate having a convex forming surface having a curvature radius smaller than a curvature radius of the concave forming surface, along the convex forming surface, to manufacture the laminate can be used.

That is, as the manufacturing method of a laminate, an aspect in which a manufacturing method of a laminate includes a step 1 of deforming a planar precursor film including a light absorption anisotropic layer and a pressure-sensitive adhesion layer or an adhesion layer, with a surface of the light absorption anisotropic layer side being on a first forming surface side, along a first forming surface using a forming die having the first forming surface, and a step 2 of deforming a precursor film, in which a shape of the first forming surface obtained in the step 1 is transferred, with a surface opposite to a surface in contact with the forming die in the step 1 on a second forming surface side of a substrate having a second forming surface having a curvature radius smaller than a curvature radius of the first forming surface, along the second forming surface, to manufacture the laminate, in which the first forming surface is a concave surface shape and the second forming surface is a convex surface shape, or the first forming surface is a convex surface shape and the second forming surface is a concave surface shape, can be used.

Hereinafter, the first aspect of the method 1 will be typically described with reference to the drawings.

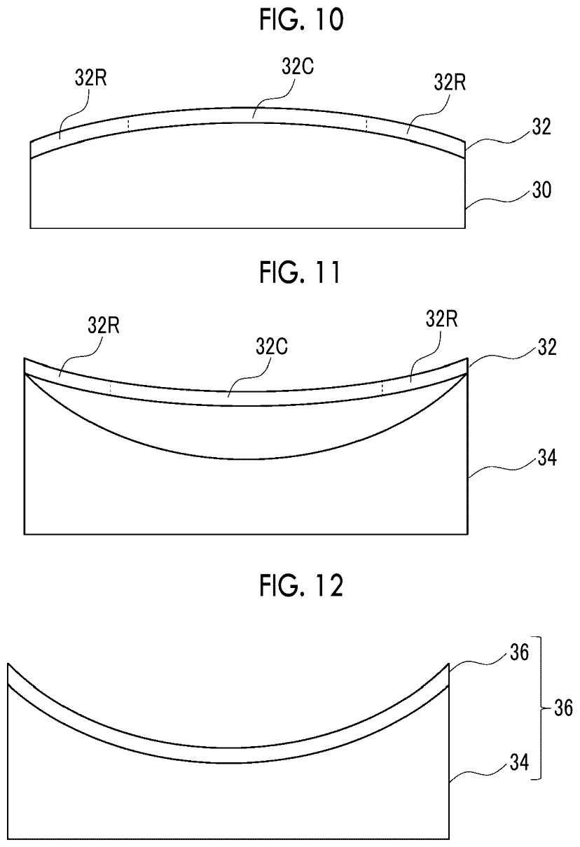

In the first aspect of the method 1, first, a step 1A of deforming a planar precursor film along a forming surface of a forming die having a convex forming surface is performed. By performing the present step, as shown in FIG. 10, a precursor film 32 in which the convex surface shape is transferred is obtained on a forming die 30 having a convex forming surface. In the precursor film 32, as described using FIGS. 8 and 9, the periphery portion 32R of the precursor film 32 is likely to be stretched more than the center portion 32C. In a case of performing the above-described forming, a surface of the planar precursor film on the light absorption anisotropic layer side is set to a forming surface side of the forming die.

Next, a step 2A of deforming a precursor film, in which a convex surface shape obtained in the step 1A is transferred, with a surface opposite to a surface in contact with the forming die in the step 1A on the forming surface side of the substrate having a concave forming surface having a curvature radius smaller than a curvature radius of the convex forming surface, along the concave forming surface, to manufacture the laminate is performed. A curvature radius of a forming surface of a substrate 34 having a concave forming surface, used in the step 2A, is smaller than a curvature radius of the forming surface of the forming die 30 having a convex forming surface, used in the step 1A. In the step 2A, first, as shown in FIG. 11, the precursor film 32 obtained in the step 1A is disposed on the substrate 34 having a forming surface having a smaller curvature radius than the forming die 30 used in the step 1A. In a case of disposing the precursor film 32 on the substrate 34, the precursor film 32 is disposed such that a surface opposite to the surface in contact with the forming die 30 is on the forming surface side of the substrate 34. Next, as shown in FIG. 12, the precursor film 32 is deformed along the forming surface of the substrate 34, whereby a laminate 36 having a curved surface shape portion is obtained. In the laminate 36, the intimate attachment layer is disposed between the substrate and the light absorption anisotropic layer.

As described using FIGS. 5 and 6, in a case of forming a concave surface, the center portion of the film is likely to be stretched more than the periphery portion.

That is, in the step 1A, the periphery portion of the precursor film is likely to be stretched more than the center portion, and in the step 2A, the center portion of the precursor film is likely to be stretched more than the periphery portion, so that in a case where the steps 1A and 2A are performed, the stretching of the center portion and the stretching of the periphery portion are the same, and as a result, the interval between the molecules is unlikely to vary in the plane of the light absorption anisotropic layer in the obtained laminate 36, and as a result, a laminate satisfying Requirement X is obtained.

Even in a case where the steps 1B and 2B are performed, in the step 1B, the center portion of the precursor film is likely to be stretched more than the periphery portion, and in the step 2B, the periphery portion of the precursor film is likely to be stretched more than the center portion, and as a result, the occurrence of the variation in the interval between the molecules is suppressed in the plane of the light absorption anisotropic layer in the obtained laminate.

In the steps 1A, 2A, 1B, and 2B, a treatment of heating the precursor film may be performed as necessary in a case where the precursor film is deformed along the forming surface. An appropriate temperature condition is selected as the heating temperature in the heating treatment according to the material and the film thickness of the precursor film to be used. Among these, the heating temperature is preferably equal to or higher than the glass transition temperature of the light absorption anisotropic layer in the precursor film. The upper limit of the heating temperature is not particularly limited, but is preferably a temperature within (Glass transition temperature of light absorption anisotropic layer+100° C.).

In the steps 1A, 2A, 1B, and 2B, a method of deforming the precursor film along the forming surface is not particularly limited, and examples thereof include a method of deforming the precursor film by vacuuming and a method of deforming the precursor film by pressurization.

In addition, in a case where the adhesion layer is used as the intimate attachment layer, a treatment (for example, an exposure treatment) of curing the adhesion layer may be performed after the step 2A or the step 2B depending on the type of the adhesion layer.

As described above, the curvature radius of the forming surface of the substrate used in the step 2A is smaller than the curvature radius of the forming surface of the forming die used in the step 1A.

A ratio (CA2/CA1) of the curvature radius (CA2) of the forming surface of the substrate used in the step 2A to the curvature radius (CA1) of the forming surface of the forming die used in the step 1A is selected as an optimal value according to the laminate to be manufactured, but is preferably 0.6 to 0.9 and more preferably 0.7 to 0.85.

In a case where the curvature radius is different depending on the position of the forming surface of the forming die used in the step 1A, the minimum curvature radius is defined as the above-described “curvature radius of the forming surface of the forming die used in the step 1A”.

In addition, in a case where the curvature radius varies depending on the position of the forming surface of the substrate used in the step 2A, the smallest curvature radius is defined as the “curvature radius of forming surface of substrate used in step 2A”.

The curvature radius of the forming surface of the substrate used in the step 2B is smaller than the curvature radius of the forming surface of the forming die used in the step 1B.

A ratio (CB2/CB1) of the curvature radius (CB2) of the forming surface of the substrate used in the step 2B to the curvature radius (CB1) of the forming surface of the forming die used in the step 1B is selected as an optimum value according to the light absorption anisotropic layer to be manufactured, but is preferably 0.6 to 0.9 and more preferably 0.7 to 0.85.

In a case where the curvature radius is different depending on the position of the forming surface of the forming die used in the step 1B, the minimum curvature radius is defined as the above-described “curvature radius of the forming surface of the forming die used in the step 1B”.

In addition, in a case where the curvature radius varies depending on the position of the forming surface of the substrate used in the step 2B, the smallest curvature radius is defined as the “curvature radius of forming surface of substrate used in step 2B”.

### <Method 2>

A method 2 is a method of forming the planar precursor film by heating the planar precursor film with a distribution of heating temperature in an in-plane direction during the forming.

As a first aspect of the method 2, a manufacturing method including a step of heating the planar precursor film such that a heating temperature of a periphery portion surrounding a center portion of the planar precursor film is higher than a heating temperature of the center portion, and deforming the heated planar precursor film along a forming surface using a substrate having a concave forming surface, with a surface (surface of the pressure-sensitive adhesion layer or the adhesion layer) of the heated planar precursor film opposite to the light absorption anisotropic layer side being on a forming surface side of the substrate having a concave forming surface, to manufacture the laminate can be used.

In addition, as a second aspect of the method 2, a manufacturing method including a step of heating the planar precursor film such that a heating temperature of a periphery portion surrounding a center portion of the planar precursor film is lower than a heating temperature of the center portion, and deforming the heated planar precursor film along a forming surface using a substrate having a convex forming surface, with a surface (surface of the pressure-sensitive adhesion layer or the adhesion layer) of the heated planar precursor film opposite to the light absorption anisotropic layer side being on a forming surface side of the substrate having a convex forming surface, to manufacture the laminate can be used.

That is, as the manufacturing method of a laminate, an aspect in which a manufacturing method of a laminate includes a step of deforming a precursor film including a light absorption anisotropic layer and a pressure-sensitive adhesion layer or an adhesion layer, with a surface of the precursor film opposite to the light absorption anisotropic layer side (surface of the pressure-sensitive adhesion layer or the adhesion layer) being on a forming surface side of a substrate having a curved surface shape, along the forming surface of the substrate, in a case where a temperature distribution is provided in an in-plane direction of the precursor film, to manufacture the laminate can be used.

Hereinafter, the first aspect of the method 2 will be typically described with reference to the drawings.

As described above, in a case of using a substrate having a concave forming surface, the center portion of the film is likely to be stretched more than the periphery portion, and the interval between the molecules is likely to be widened.

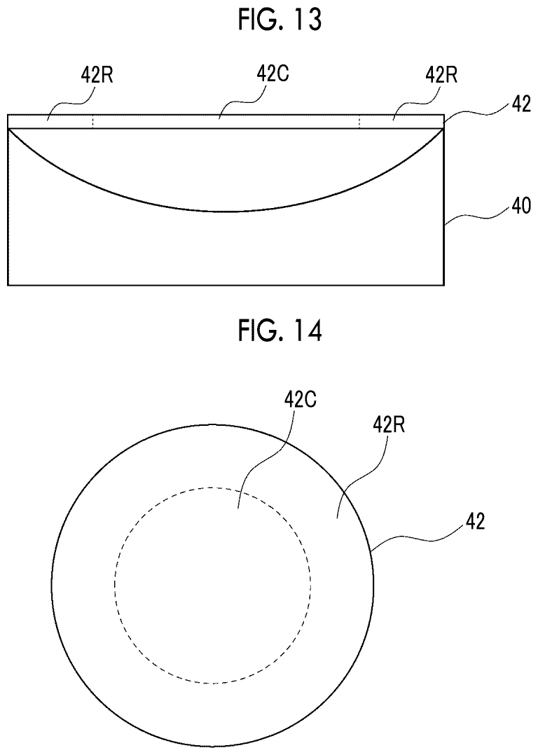

Therefore, in the first aspect of the method 2, as shown in FIGS. 13 and 14, the heating temperature of the periphery portion 42R is set to be higher than the heating temperature of the center portion 42C of the planar precursor film 42 disposed on the substrate 40 having a concave forming surface, whereby the periphery portion 42R is likely to be stretched in a case of deforming the precursor film 42 along the forming surface. That is, as described above, in a case of forming using a substrate having a concave forming surface, the center portion is likely to be stretched more than the periphery portion, but by changing the heating conditions of the center portion and the periphery portion, the center portion is less likely to be stretched and the periphery portion is more likely to be stretched.

In the second aspect of the method 2, in a case of forming using a substrate having a convex forming surface, the periphery portion is likely to be stretched more than the center portion, but by changing the heating conditions of the center portion and the periphery portion, the periphery portion is less likely to be stretched and the center portion is more likely to be stretched.

A heating condition of the precursor film in the method 2 is appropriately selected as an optimal condition according to the type of the material of the precursor film to be used and the shape of the curved surface shape portion.

Among these, the heating temperature is preferably equal to or higher than the glass transition temperature of the light absorption anisotropic layer in the precursor film. The upper limit of the heating temperature is not particularly limited, but is preferably a temperature within (Glass transition temperature of light absorption anisotropic layer+100° C.).

The heating method in the method 2 is not particularly limited, and examples thereof include heating by bringing the light absorption anisotropic layer into contact with a heated solid, heating by bringing the light absorption anisotropic layer into contact with a heated liquid, heating by bringing the light absorption anisotropic layer into contact with a heated gas, heating by irradiation with infrared rays, and heating by irradiation with microwaves. Among these, heating by irradiation with infrared rays is preferable because it allows for remote heating just before the forming.

A wavelength of the infrared rays used for the heating is preferably 1.0 to 30.0 m and more preferably 1.5 to 5 km.

Examples of the infrared ray (IR) light source include a near-infrared lamp heater in which a tungsten filament is enclosed into a quartz tube, and a wavelength control heater in which a mechanism for cooling a part between quartz tubes with air is provided by multiplexing the quartz tubes. As a method of providing intensity distribution of the infrared irradiation, a method of varying the density of the arrangement of the IR light sources, or a method of placing a filter with a patterned transmittance to infrared light between the IR light sources and the planar precursor film can be used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, or the like is used. The temperature of the planar precursor film is controlled by the intensity of the infrared irradiation and is controlled by the infrared irradiation time and the illuminance of the infrared irradiation. The temperature of the planar precursor film can be monitored using a non-contact radiation thermometer, a thermocouple, or the like, and can be formed at a target temperature.

In addition, in a case where the adhesion layer is used as the intimate attachment layer, a treatment (for example, an exposure treatment) of curing the adhesion layer may be performed after the deformation depending on the type of the adhesion layer.

### [Other Aspects of Laminate]

The laminate according to the embodiment of the present invention may include a layer other than the above-described substrate, pressure-sensitive adhesion layer, adhesion layer, and light absorption anisotropic layer.

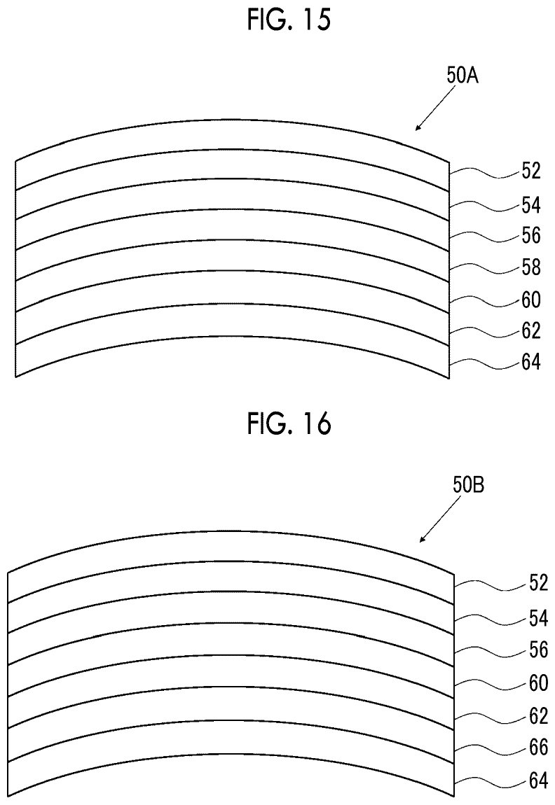

For example, as shown in FIG. 15, a laminate 50A includes a half mirror 52, a substrate 54, a pressure-sensitive adhesion layer 56, a cholesteric liquid crystal layer 58, a positive C plate 60, a phase difference layer 62 having a function of converting linearly polarized light into circularly polarized light, and a light absorption anisotropic layer 64 in this order. The laminate 50A corresponds to an aspect in which a cholesteric liquid crystal layer is included.

In addition, as shown in FIG. 16, a laminate 50B includes a half mirror 52, a substrate 54, a pressure-sensitive adhesion layer 56, a positive C plate 60, a phase difference layer 62 having a function of converting linearly polarized light into circularly polarized light, a reflective linear polarizer 66, and a light absorption anisotropic layer 64 in this order. The laminate 50B corresponds to an aspect in which a phase difference layer and a reflective linear polarizer are included.

As shown in FIGS. 15 and 16, any member included in the laminate 50A and the laminate 50B has a curved surface shape.

In a case where the retardation layer 62 in the laminate 50A and the laminate 50B is a λ/4 plate, an angle formed by a slow axis of the retardation layer 62 and a transmission axis of the light absorption anisotropic layer 64 is preferably within a range of 45°±10°.

The laminate 50A and the laminate 50B include two retardation layers of the retardation layer 62 and the positive C-plate 60. The phase difference layer is not limited to the phase difference layer having a function of converting linearly polarized light into circularly polarized light and the positive C plate, and may be in another aspect.

A retardation layer having a function of converting linearly polarized light into circularly polarized light may be further disposed on a side of the light absorption anisotropic layer 64 of the laminate 50A, opposite to the retardation layer 62 side. In addition, a phase difference layer having a function of converting linearly polarized light into circularly polarized light may be further disposed on a side of the light absorption anisotropic layer 64 of the laminate 50B opposite to the reflective linear polarizer 66.

Further, an antireflection layer on a surface may be disposed on a side of the light absorption anisotropic layer 64 of the laminate 50A opposite to the phase difference layer 62. In addition, an antireflection layer on a surface may be further disposed on a side of the light absorption anisotropic layer 64 of the laminate 50B opposite to the reflective linear polarizer 66.

In addition, the laminate 50A and the laminate 50B may further include an alignment film disposed adjacent to the light absorption anisotropic layer 64.

The laminates 50A and 50B are suitably applied to a virtual reality display apparatus described later.

The configurations of the substrate 54, the pressure-sensitive adhesion layer 56, and the light absorption anisotropic layer 64 are as described above.

Hereinafter, other members included in the laminate will be described in detail.

### <Half Mirror>

The half mirror may be, for example, a half mirror known in the related art that transmits about half of the incident light and reflects the remaining about half of the incident light.

A transmittance of the half mirror is preferably 50±30% and more preferably 50±10%.

The type of the half mirror is not particularly limited, and examples thereof include a reflective layer containing a metal. Examples of the metal include silver and aluminum.

The thickness of the half mirror is preferably 1 to 20 nm, more preferably 2 to 10 nm, and still more preferably 3 to 6 nm.

### <Cholesteric Liquid Crystal Layer>

The cholesteric liquid crystal layer is an optical member which separates incidence ray into right-circularly polarized light and left-circularly polarized light, and specularly reflects one circularly polarized light and transmits the other circularly polarized light.

Examples of the cholesteric liquid crystal layer include a cholesteric liquid crystal layer obtained by fixing a cholesteric liquid crystalline phase. From the viewpoint that a decrease in polarization degree and a distortion of a polarization axis are suppressed in a case of being stretched or formed into a three-dimensional shape, the cholesteric liquid crystal layer is preferably used as an optical film for curved surface forming. In addition, a decrease in polarization degree due to the distortion of the polarization axis is unlikely to occur.

It is preferable that the cholesteric liquid crystal layer includes a blue light reflecting layer in which at least reflectivity at a wavelength of 460 nm is 40% or more, a green light reflecting layer in which a reflectivity at a wavelength of 550 nm is 40% or more, a yellow light reflecting layer in which a reflectivity at a wavelength of 600 nm is 40% or more, and a red light reflecting layer in which a reflectivity at a wavelength of 650 nm is 40% or more. With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the cholesteric liquid crystal layer may have a pitch gradient structure in which a helical pitch of the cholesteric liquid crystalline phase continuously changes in the thickness direction.

In addition, it is also preferable that a cholesteric liquid crystal layer obtained by fixing a cholesteric liquid crystalline phase containing a rod-like liquid crystal compound and a cholesteric liquid crystal layer obtained by fixing a cholesteric liquid crystalline phase containing a disk-like liquid crystal compound are used in combination as the cholesteric liquid crystal layer. In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the ghost can be suppressed even for the light incident from the oblique direction, which is preferable.

A thickness of the cholesteric liquid crystal layer is not particularly limited, but from the viewpoint of thinning, it is preferably 30 m or less and more preferably 15 m or less. The lower limit thereof is not particularly limited, but is 1 m or more in many cases.

### <Positive C-Plate>

The positive C-plate is one type of retardation layer.

The positive C-plate is a retardation layer in which an in-plane retardation is substantially zero and a thickness-direction retardation has a negative value. The positive C-plate functions as an optical compensation layer for increasing the polarization degree of the transmitted light with respect to light incident obliquely.

The in-plane retardation of the positive C-plate at a wavelength of 550 nm is preferably 10 nm or less.

The thickness-direction retardation of the positive C-plate at a wavelength of 550 nm is preferably −600 to −40 nm.

A material constituting the positive C-plate is not particularly limited, but it is preferable that the positive C-plate is formed of a composition containing a liquid crystal compound. Such a positive C-plate can be typically obtained by vertically aligning a rod-like polymerizable liquid crystal compound contained in the polymerizable liquid crystal composition and fixing the alignment state by polymerization. In addition, the positive C-plate can also be formed of a composition containing a side chain-type polymer liquid crystal compound as the liquid crystal compound.

A thickness of the positive C-plate is not particularly limited, but from the viewpoint of thinning, it is preferably 0.5 to 10 m and more preferably 0.5 to 5 m.

<Retardation Layer Having Function of Converting Linearly Polarized Light into Circularly Polarized Light>

The retardation layer having a function of converting linearly polarized light into circularly polarized light (hereinafter, also simply referred to as “specific retardation layer”) is one kind of retardation layer.

The specific retardation layer is not particularly limited as long as it has a function of converting linearly polarized light into circularly polarized light, and examples thereof include a λ/4 plate.

The λ/4 plate is a plate having a λ/4 function, specifically, a plate having a function of converting linearly polarized light having a specific wavelength (preferably, visible light) into circularly polarized light (or converting circularly polarized light into linearly polarized light).

An in-plane retardation of the λ/4 plate at a wavelength of 550 nm is not particularly limited, but is preferably 120 to 150 nm, more preferably 125 to 145 nm, and still more preferably 135 to 140 nm.

In addition to the λ/4 plate, a retardation layer in which an in-plane retardation at a wavelength of 550 nm is 3/4 or 5/4 of a wavelength of any light of visible light is also preferable.

The specific retardation layer may have reverse wavelength dispersibility. The expression “having reverse wavelength dispersibility” denotes that as the wavelength increases, the value of the phase difference at the wavelength increases.

In addition, the specific retardation layer may have a multilayer structure, and specific examples thereof include a broadband λ/4 plate obtained by laminating a λ/4 plate and a λ/2 plate.

An angle formed by a slow axis of the specific retardation layer and an absorption axis of the light absorption anisotropic layer is not particularly limited, but is preferably within a range of 45°±10°.

The specific retardation layer may be a layer formed by immobilizing a liquid crystal compound twist-aligned with a thickness direction as a helical axis. For example, a retardation layer having a layer formed by immobilizing a rod-like liquid crystal compound or a disk-like liquid crystal compound twist-aligned with a thickness direction as a helical axis, as described in JP5753922B and JP5960743B, can be used.

A thickness of the specific retardation layer is not particularly limited, but is preferably 0.1 to 8 m and more preferably 0.3 to 5 m.

### <Reflective Linear Polarizer>

The reflective linear polarizer is a polarizer that has a function of reflecting one linearly polarized light of linearly polarized light components orthogonal to each other and allowing transmission of the other linearly polarized light.

An angle formed by the transmission axis of the reflective linear polarizer and the transmission axis of the light absorption anisotropic layer is preferably in a range of 0° to 10°.

Examples of the reflective linear polarizer include a film obtained by stretching a dielectric multilayer film and a wire grid polarizer. Examples of a commercially available product include a reflective type polarizer (trade name: APF) manufactured by 3M and a wire grid polarizer (trade name: WGF) manufactured by Asahi Kasei Corporation.

### <Surface Antireflection Layer>

The laminate according to the embodiment of the present invention may include a surface antireflection layer.

In the laminate according to the embodiment of the present invention, the surface antireflection layer is preferably disposed on the outermost surface side. The surface antireflection layer may be disposed only on one surface side of the laminate, or may be disposed on both surface sides of the laminate.

The type of the surface antireflection layer is not particularly limited, but from the viewpoint of further decreasing the reflectivity, a moth-eye film or an anti reflection (AR) film is preferable. In addition, since the antireflection property can be maintained even in a case where the film thickness fluctuates due to stretching and forming, a moth-eye film is preferable.

### <Alignment Film>

The laminate according to the embodiment of the present invention may have an alignment film. As described above, in the laminate, it is preferable that the alignment film is adjacent to the light absorption anisotropic layer.

The type of the alignment film is not particularly limited, and the alignment film can be formed by, for example, a rubbing treatment of an organic compound (preferably a polymer), oblique vapor deposition of an inorganic compound, formation of a layer having a microgroove, or a method such as accumulation of an organic compound (for example, o-tricosanoic acid, dioctadecylmethylammonium chloride, and methyl stearate) by a Langmuir-Blodgett method (LB film). Examples thereof include a rubbed alignment film.

Further, an alignment film is also known that exhibits an alignment function by application of an electric field, application of a magnetic field, or irradiation with light (preferably polarized light).

As the alignment film, a photo-alignment film is also preferable.

The alignment film is preferably a layer formed of a composition (a composition for forming an alignment film) containing a compound having an active hydrogen reactive group.

Examples of the active hydrogen reactive group include the above-described groups.

The above-described compound preferably further has an active hydrogen-containing group in addition to the active hydrogen reactive group. In the present specification, the “active hydrogen-containing group” means a functional group containing active hydrogen.

Examples of the active hydrogen-containing group include a hydroxyl group, a carboxyl group, an amino group, a mercapto group, a primary amide group, a secondary amide group, and a hydrazide group.

Examples of the above-described compound having an active hydrogen reactive group include a silane coupling agent.

Examples of the silane coupling agent include compounds described in paragraphs 0050 and 0051 of JP2022-120660A.

The composition for forming an alignment film preferably contains a polymer containing a structural unit having a photoreactive group and a structural unit having a polymerizable group.

The structural unit having a photoreactive group is derived from at least one monomer having at least one photoreactive group. The photoreactive group refers to a group that generates liquid crystal alignment ability by light irradiation. Specifically, it means a group that generates a photoreaction, which is a source of liquid crystal alignment ability, such as a dimerization reaction, an isomerization reaction, or a photodecomposition reaction, by light irradiation to induce alignment of a polymer molecule.

The structural unit having a polymerizable group is derived from at least one monomer having at least one polymerizable group. The polymerizable group means a group involved in a polymerization reaction, and examples thereof include a thermally polymerizable group and a photopolymerizable group, but the polymerizable group contained in the structural unit having a polymerizable group is preferably a photopolymerizable group.

Examples of the above-described polymer include aspects described in paragraphs 0020 to 0041 of JP2021-196514A.

### [Virtual Reality Display Apparatus]

The virtual reality display apparatus according to the embodiment of the present invention includes the above-described laminate.

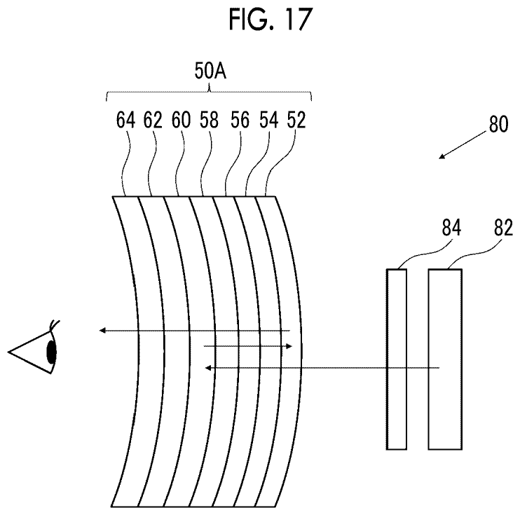

FIG. 17 is a schematic view showing an example of a configuration of the virtual reality display apparatus.

A virtual reality display apparatus 80 shown in FIG. 17 includes an image display panel 82, a circularly polarizing plate 84, and the laminate 50A according to the embodiment of the present invention from the right side in the drawing. As described above, the laminate 50A used in FIG. 17 includes the half mirror 52, the substrate 54, the pressure-sensitive adhesion layer 56, the cholesteric liquid crystal layer 58, the positive C plate 60, the phase difference layer 62 having a function of converting linearly polarized light into circularly polarized light, and the light absorption anisotropic layer 64 in this order.

In the virtual reality display apparatus 80 shown in FIG. 17, a ray 92 emitted from an image display panel 82 is transmitted through a circularly polarizing plate 84 to be circularly polarized light, and is transmitted through a half mirror 52. Next, the rays transmit through the substrate 54, are incident on and reflected by the cholesteric liquid crystal layer 58, transmit through the substrate 54 again, are reflected by the half mirror 52 again, and transmit through the substrate 54 again to be incident on the cholesteric liquid crystal layer 58. In this case, the circularly polarized state of the rays does not change in a case of being reflected by the cholesteric liquid crystal layer 58, and changes to circularly polarized light having a rotation direction opposite to the circularly polarized light incident on the cholesteric liquid crystal layer 58 in a case of being reflected by the half mirror 52. Accordingly, the rays transmit through the cholesteric liquid crystal layer 58 and are visually recognized by the user. In addition, in a case where the ray is reflected by the half mirror 52, since the half mirror 52 has a concave mirror shape, the image is magnified so that the user can visually recognize the magnified virtual image. The system described above is referred to as a reciprocating optical system, a folded optical system, or the like.

The light absorption anisotropic layer 64 included in the laminate 50A functions as a so-called linear polarizer, and is used to prevent light which is unnecessarily transmitted through the cholesteric liquid crystal layer 58 from being observed by the user of the virtual reality display apparatus as a leakage light (ghost).

In the above, an aspect in which the laminate 50A is used has been described, but the present invention is not limited to this aspect, and the laminate 50B may be used instead of the laminate 50A.

The image display panel 82 is, for example, a known image display panel (display panel) such as an organic electroluminescence display panel.

In the illustrated example, the image display panel 82 emits an image (image light) of unpolarized light. The unpolarized image emitted from the image display panel 82 passes through the circularly polarizing plate 84, and is converted into circularly polarized light.

### EXAMPLES

Hereinafter, the present invention will be described in more detail with reference to Examples. The materials, the amounts of materials used, the proportions, the treatment details, and the treatment procedure in Examples below may be appropriately modified as long as the modifications do not depart from the spirit of the present invention. Therefore, the scope of the present invention should not be construed as being limited to Examples shown below.

### Example 1

### <Production of Absorptive Polarizer Film 1>

### (Production of Support)

The following composition was put into a mixing tank, stirred, and heated at 90° C. for 10 minutes. Thereafter, the obtained composition was filtered through a filter paper having an average hole diameter of 34 m and a sintered metal filter having an average hole diameter of 10 m to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | | |
|---|---|---|
| Cellulose acylate | 100 | parts by mass |
| (acetyl substitution degree of 2.86, viscosity | | |
| average polymerization degree of 310): | | |
| Sugar ester compound 1 (Formula (S4) shown | 6.0 | parts by mass |
| below) | | |
| Sugar ester compound 2 (Formula (S5) shown | 2.0 | parts by mass |
| below) | | |
| Silica particle dispersion liquid | 0.1 | parts by mass |
| (AEROSIL R972, manufactured by Nippon | | |
| Aerosil Co., Ltd.): | | |
| Solvent (methylene chloride/methanol/butanol) | 351.9 | parts by mass |

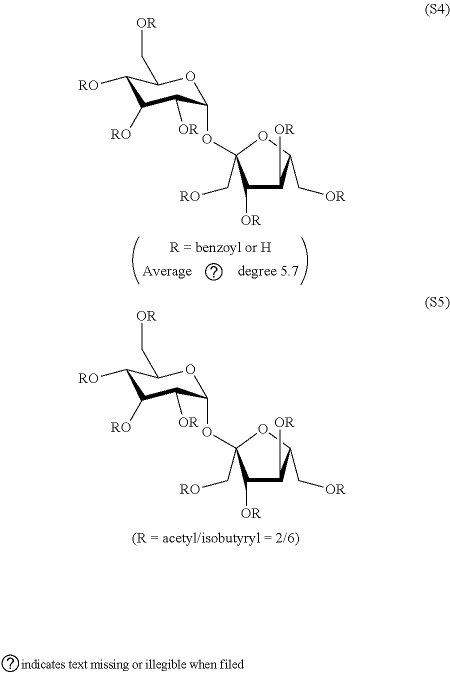

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, and the tenter device transported the web by clipping both ends of the web. Subsequently, the web was post-dried by zone heating while being rolled. The obtained web was subjected to knurling and then wound to obtain a cellulose acylate film A1.

In the obtained cellulose acylate film A1, a film thickness was 60 m, an in-plane retardation Re(550) at a wavelength of 550 nm was 1 nm, and a thickness-direction retardation Rth(550) at a wavelength of 550 nm was 35 nm.

### (Formation of Photo-Alignment Film B1)

A cellulose acylate film A1 described below was continuously coated with a composition B1 for forming a photo-alignment film described below with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 m.

Formulation of composition B1 for forming photo-alignment film

| | | |
|---|---|---|
| Photo-alignment compound PA-1 shown below | 100.00 | parts by mass |
| EPICLON N-695 (manufactured by DIC Corporation) | 55.74 | parts by mass |
| jER YX7400 (manufactured by Mitsubishi Chemical Corporation) | 18.75 | parts by mass |
| Polymerizable polymer PA-2 shown below | 8.01 | parts by mass |
| Thermal cationic polymerization initiator PAG-1 shown below | 16.75 | parts by mass |
| Stabilizer DIPEA shown below3-Aminopropyltriethoxysilane | 1.06 | parts by mass |
| (product name: KBE-903, manufactured by Shin-Etsu Chemical | 1.0 | part by mass |
| Co., Ltd.) | | |
| Butyl acetate | 1230.49 | parts by mass |

Photo-alignment compound PA-1 (weight-average molecular weight: 32,000)

(in the formula, the numerical value described in each repeating unit denotes the content (% by mass) of each repeating unit with respect to all repeating units)

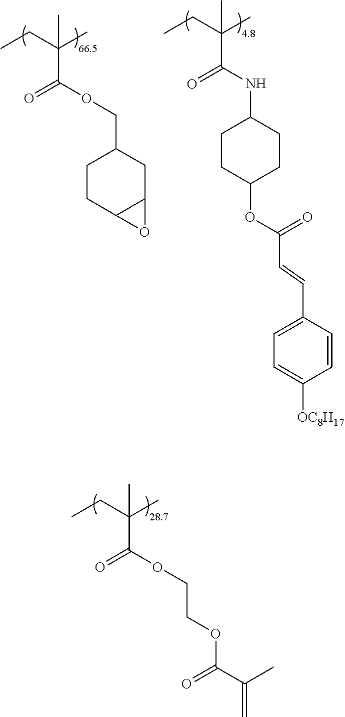

Polymerizable polymer PA-2 (weight-average molecular weight: 18,000)

(in the formula, numerical values of a, b, and c represent contents (% by mass) of each repeating unit with respect to all the repeating units)

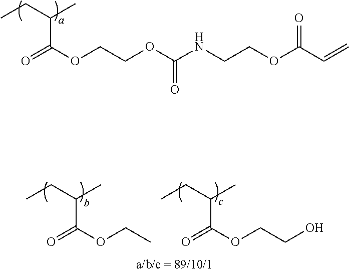

Thermal cationic polymerization initiator PAG-1

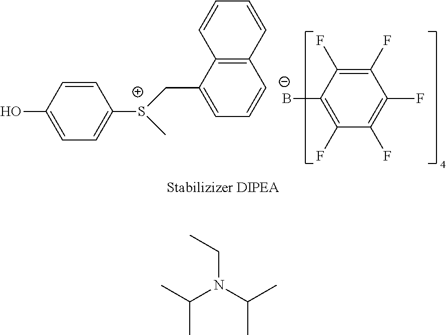

### (Formation of Light Absorption Anisotropic Layer C1)

A coating film was formed by continuously coating the obtained photo-alignment film B1 with a composition C1 for forming a light absorption anisotropic layer, having the following formulation, with a wire bar.

Next, the coating film was heated at 110° C. for 120 seconds, and the coating film was rapidly cooled to room temperature (23° C.).

Thereafter, the coating film was irradiated with ultraviolet rays at an exposure amount of 1000 mJ/cm² (365 nm basis) using a high-pressure mercury lamp to form a light absorption anisotropic layer C1 having a thickness of 1.7 m.

A content of the dichroic substance in the light absorption anisotropic layer C1 was 80 mg/cm³.

The following composition C1 for forming a light absorption anisotropic layer was heated and dissolved at 80° C. for 2 hours while stirring the components described below, and filtered through a 0.45 μm filter to be produced.

Composition C1 for forming light absorption anisotropic layer

| | | |
|---|---|---|
| Liquid crystal compound L1 shown below | 75 | parts by mass |
| Liquid crystal compound L2 shown below | 25 | parts by mass |
| Dichroic substance Al shown below | 3 | parts by mass |
| Dichroic substance A2 shown below | 3 | parts by mass |
| Dichroic substance A3 shown below | 1 | part by mass |
| Dichroic substance A4 shown below | 1 | part by mass |
| 2-Dimethylamino-2-benzyl-1- | | |
| (4-morpholinophenyl)butan-1-one | 6 | parts by mass |
| (IRGACURE manufactured | | |
| by BASF SE) | | |
| Polyacrylate compound (BYK-361N, | 1.2 | parts by mass |
| manufactured by BYK-Chemie GmbH) | | |
| Laromer (registered trademark) LR-9000 | 2 | parts by mass |
| o-xylene | 250 | parts by mass |

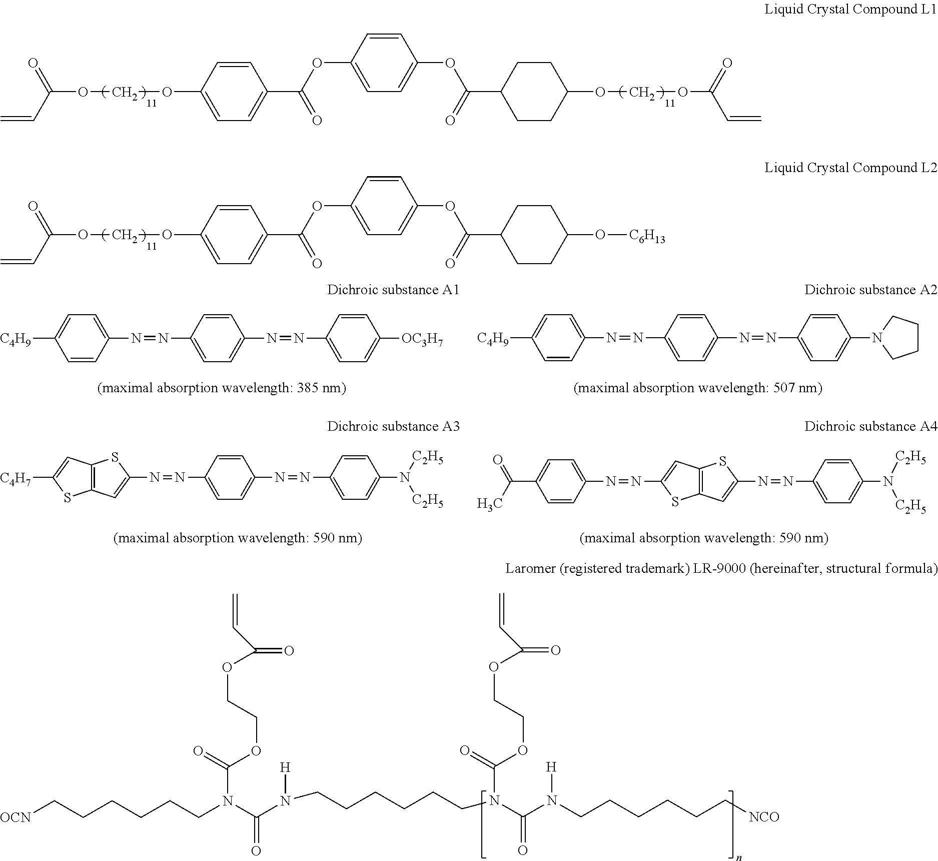

### (Formation of Protective Layer D1)

The light absorption anisotropic layer C1 was continuously coated with a coating liquid D1 for forming a protective layer, having the following formulation, with a wire bar.

Thereafter, the coating film was dried with hot air at 80° C. for 5 minutes and irradiated with light at an irradiation amount of 300 mJ using a light emitting diode (LED) lamp (central wavelength: 365 nm) to obtain a laminate with the protective layer D1 consisting of polyvinyl alcohol (PVA) and having a thickness of 0.6 m was formed, that is, an absorptive polarizer film 3 in which the cellulose acylate film A1 (support), the photo-alignment film B2, the light absorption anisotropic layer C2, and the protective layer D1 were provided adjacent to each other in this order.

Formulation of coating liquid D1 for forming protective layer

| | | |
|---|---|---|
| Modified polyvinyl alcohol shown below | 3.31 | parts by mass |
| Initiator IRGACURE 2959 | 0.17 | parts by mass |
| (manufactured by BASF SE) | | |
| Glutaraldehyde | 0.07 | parts by mass |
| Pyridinium paratoluene sulfonate | 0.05 | parts by mass |
| Surfactant F-9 shown below | 0.0018 | parts by mass |
| Water | 74.0 | parts by mass |
| Ethanol | 22.4 | parts by mass |

Modified polyvinyl alcohol (weight-average molecular weight: 28,000)

(in the formula, the numerical value described in each repeating unit denotes the content (% by mass) of each repeating unit with respect to all repeating units)

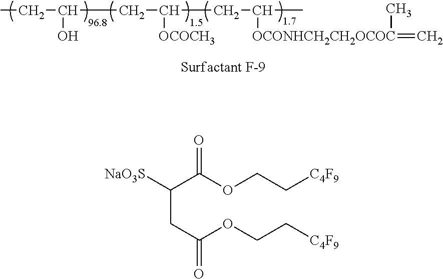

### <Production of Retardation Layer Film 1 Including Positive A-Plate>

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.2 m, thereby obtaining a TAC film with the photo-alignment film.

Coating liquid E1 for forming photo-alignment film

| | | |
|---|---|---|
| Polymer PA-2 shown below | 100.00 | parts by mass |
| Thermal cationic polymerization | 5.00 | parts by mass |
| initiator PAG-1 shown above | | |
| Acid generator CPI-110TF | 0.005 | parts by mass |
| shown below | | |
| Isopropyl alcohol | 16.50 | parts by mass |
| Butyl acetate | 1072.00 | parts by mass |
| Methyl ethyl ketone | 268.00 | parts by mass |

Polymer PA-2 (weight-average molecular weight: 45,000)

(in the formula, the numerical value described in each repeating unit denotes the content (% by mass) of each repeating unit with respect to all repeating units)

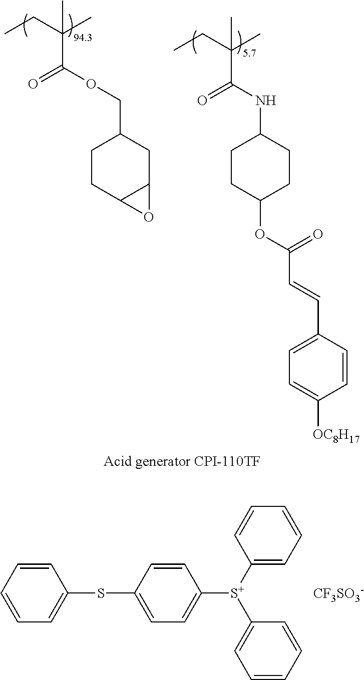

The above-described photo-alignment film E1 was coated with a composition F1 having the following formulation with a bar coater. The coating film formed on the photo-alignment film E1 was heated to 120° C. with hot air, cooled to 60° C., irradiated with ultraviolet rays having a wavelength of 365 nm with an illuminance of 100 mJ/cm² using a high-pressure mercury lamp in a nitrogen atmosphere, and continuously irradiated with ultraviolet rays with an illuminance of 500 mJ/cm² while being heated at 120° C., so that the alignment of the liquid crystal compound was immobilized, thereby producing a retardation layer 1 including a positive A-plate F1.

A thickness of the positive A-plate F1 was 2.5 m, and an Re(550) was 144 nm. In addition, the positive A-plate satisfied a relationship of “Re(450)≤Re(550)≤Re(650)”. Re(450)/Re(550) was 0.82. The above-described positive A-plate corresponds to a so-called λ/4 plate.

Composition F1

| | | |
|---|---|---|
| Polymerizable liquid crystal | 43.50 | parts by mass |
| compound LA-1 shown below | | |
| Polymerizable liquid crystal | 43.50 | parts by mass |
| compound LA-2 shown below | | |
| Polymerizable liquid crystal | 8.00 | parts by mass |
| compound LA-3 shown below | | |
| Polymerizable liquid crystal | | |
| compound LA-4 shown below | 5.00 | parts by mass |
| Polymerization initiator | | |
| PI-1 shown below | 0.55 | parts by mass |
| Leveling agent T-1 shown below | 0.20 | parts by mass |
| Cyclopentanone | 235.00 | parts by mass |

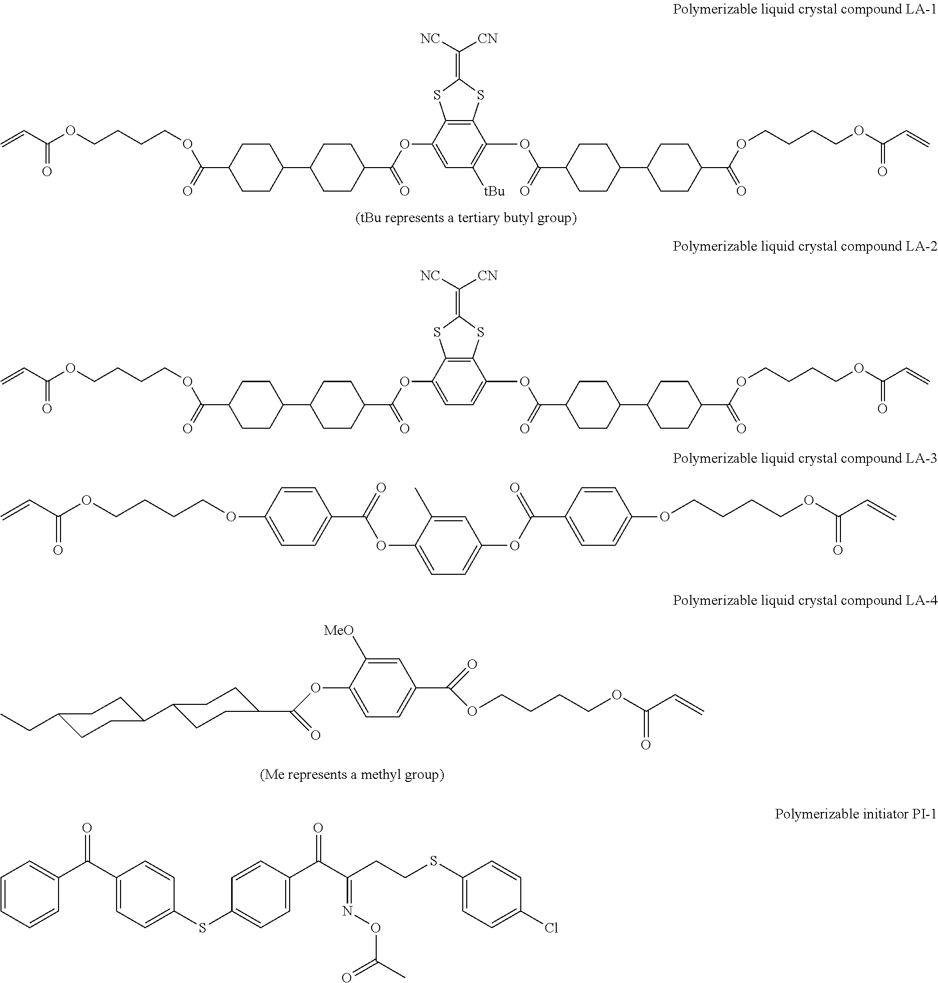

Leveling agent T-1 (weight-average molecular weight: 25,000)

(in the formula, the numerical value described in each repeating unit denotes the content (% by mass) of each repeating unit with respect to all repeating units)

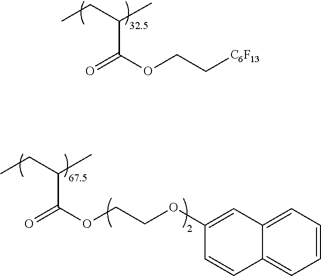

### <Production of Retardation Layer Film 2 Including Positive C-Plate>

The above-described cellulose acylate film A1 was used as a temporary support.

After passing the cellulose acylate film A1 through a dielectric heating roll at a temperature of 60° C. to raise the film surface temperature to 40° C., an alkaline solution having the formulation shown below was applied onto one surface of the film using a bar coater at a coating amount of 14 ml/m², followed by heating to 110° C., and transportation of the film under a steam type far-infrared heater manufactured by Noritake Company Limited for 10 seconds.

Next, the film was coated with pure water such that the coating amount reached 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

(Alkaline solution)

| | | |
|---|---|---|
| Potassium hydroxide | 4.7 | parts by mass |
| Water | 15.8 | parts by mass |
| Isopropanol | 63.7 | parts by mass |
| Fluorine-containing | 1.0 | parts by mass |
| surfactant SF-1 | | |
| (C₁₄H_{29O}(CH₂CH₂O)₂₀H) | | |
| Propylene glycol | 14.8 | parts by mass |

The cellulose acylate film A1 which had been subjected to the alkali saponification treatment was continuously coated with a coating liquid G1 for forming an alignment film, having the following formulation, using a #8 wire bar. The obtained film was dried with hot air at 60° C. for 60 seconds, and further dried with hot air at 100° C. for 120 seconds to form an alignment film G1.

Coating liquid G1 for forming alignment film

| | | |
|---|---|---|
| Polyvinyl alcohol | 2.4 | parts by mass |
| (PVA103 manufactured | | |
| by Kuraray Co., Ltd.) | | |
| Isopropyl alcohol | 1.6 | parts by mass |
| Methanol | 36 | parts by mass |
| Water | 60 | parts by mass |

The alignment film G1 was coated with a coating liquid H1 for forming a positive C-plate, having the following formulation, the obtained coating film was aged at 60° C. for 60 seconds and irradiated with ultraviolet rays at an illuminance of 1000 mJ/cm² in the air using an air-cooled metal halide lamp at an illuminance of 70 mW/cm² (manufactured by Eye Graphics Co., Ltd.), and the alignment state thereof was fixed to vertically align the liquid crystal compound, thereby producing a retardation layer film 2 including a positive C-plate H1 with a thickness of 0.5 m.

Rth(550) of the obtained positive C-plate was −60 nm.

Coating liquid H1 for forming positive C-plate

| | | |
|---|---|---|
| Liquid crystal compound | 80 | parts by mass |
| LC-1 shown below | | |
| Liquid crystal compound | 20 | parts by mass |
| LC-2 shown below | | |
| Vertically aligned liquid | 1 | part by mass |
| crystal compound S01 shown below | | |
| Ethylene oxide-modified trimethylolpropane | 8 | parts by mass |
| triacrylate (V#360, manufactured by | | |
| Osaka Organic Chemical Industry Ltd.) | | |
| IRGACURE 907 (manufactured by BASF SE) | 3 | parts by mass |
| KAYACURE DETX (manufactured | 1 | part by mass |
| by Nippon Kayaku Co., Ltd.) | | |
| Compound B03 shown below | 0.4 | parts by mass |
| Methyl ethyl ketone | 170 | parts by mass |
| Cyclohexanone | 30 | parts by mass |

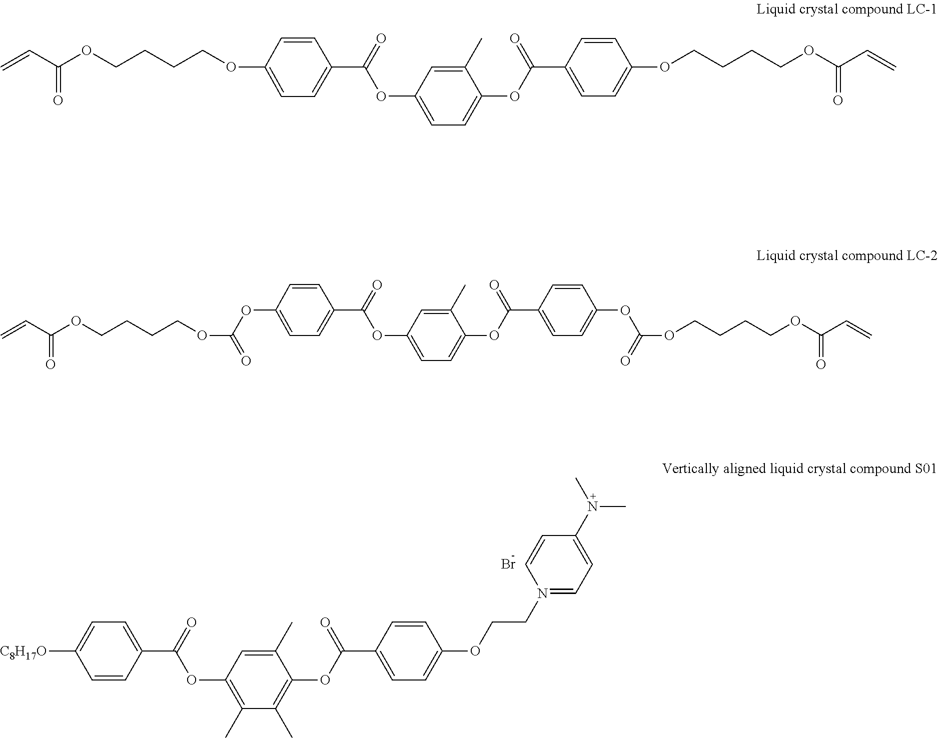

Compound B03 (weight-average molecular weight: 15,000)

(in the formula, the numerical value described in each repeating unit denotes the content (% by mass) of each repeating unit with respect to all repeating units)

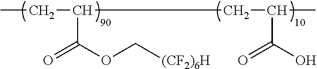

### <Production of Retardation Layer Film 3 Including Positive C-Plate/Positive A-Plate>

### (Formation of Second Optically Anisotropic Layer)

The following rod-like liquid crystal compound A (83 parts by mass), the following rod-like liquid crystal compound B (15 parts by mass), the following rod-like liquid crystal compound C (2 parts by mass), an acrylate monomer (A-400, manufactured by Shin-Nakamura Chemical Co., Ltd.) (4.2 parts by mass), the following polymer A (2 parts by mass), the following vertical alignment agent A (1.9 parts by mass), the following photopolymerization initiator A (5.1 parts by mass), the following photoacid generator A (3 parts by mass), and the following photo-alignment polymer B (0.8 parts by mass) were dissolved in methyl isobutyl ketone (567 parts by mass) to prepare a composition 1 for forming a second optically anisotropic layer.

The prepared composition 1 for forming a second optically anisotropic layer was applied onto the above-described cellulose acylate film A1 with a #3.0 wire bar, heated at 70° C. for 2 minutes, and irradiated with ultraviolet rays of 150 mJ/cm² at an oxygen concentration of less than 100 ppm. Thereafter, by performing annealing for 1 minute at 120° C., a second optically anisotropic layer was formed.

The second optically anisotropic layer was a positive C-plate satisfying the expression (C1) of nz>nx≈ny, and had a film thickness of approximately 0.5 m.

### Rod-Like Liquid Crystal Compound A

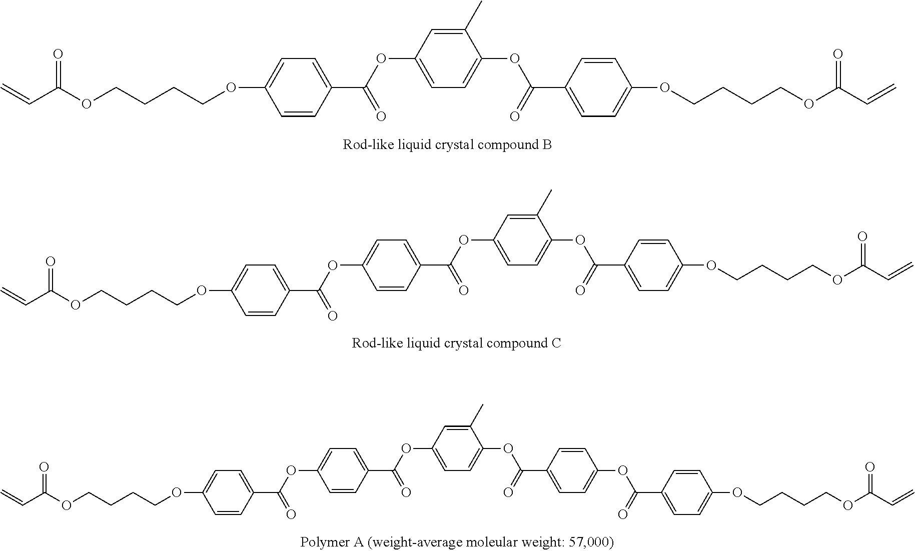

(in the formula, the numerical value described in each repeating unit denotes the content (% by mass) of each repeating unit with respect to all repeating units)

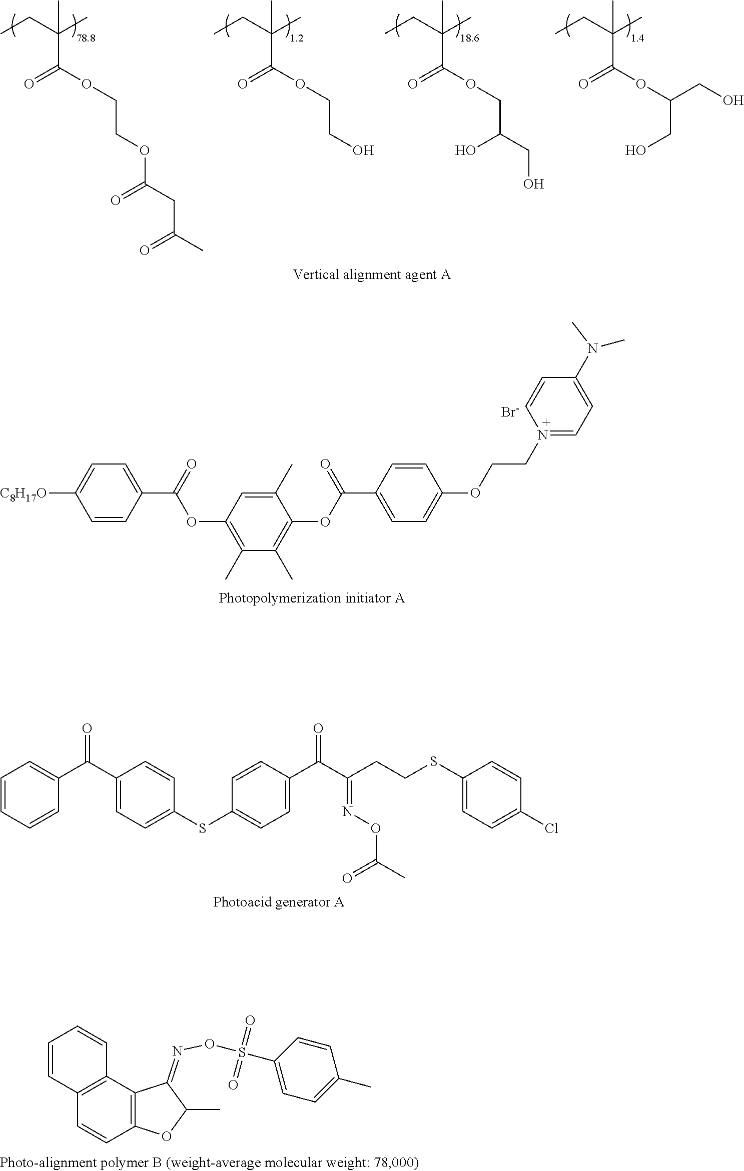

(in the following formula, a to c are a:b:c=17:64:19, and indicate the content (% by mass) of each repeating unit with respect to all repeating units in the polymer)

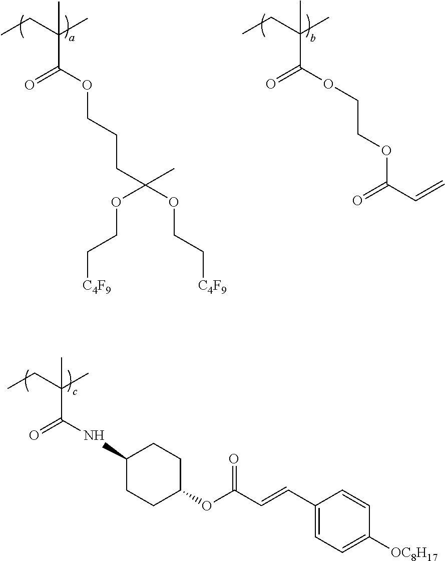

### (Irradiating Step (Impartment of Alignment Function))

The obtained second optically anisotropic layer was irradiated with ultraviolet light (UV light) (ultra-high pressure mercury lamp; UL750; manufactured by HOYA CANDEO OPTRONICS CORPORATION) passing through a wire grid type polarizer at room temperature with 7.9 mJ/cm² (wavelength: 313 nm) to impart an alignment function.

### (Formation of First Optically Anisotropic Layer (Upper Layer))

The above-described rod-like liquid crystal compound A (7.0 parts by mass), the above-described rod-like liquid crystal compound B (1.3 parts by mass), the above-described rod-like liquid crystal compound C (0.2 parts by mass), the following rod-like liquid crystal compound D (21.2 parts by mass), the following rod-like liquid crystal compound E (26.1 parts by mass), the following rod-like liquid crystal compound F (29.0 parts by mass), the following compound G (15.3 parts by mass), the following polymerizable compound M1 (5 parts by mass), the above-described photopolymerization initiator A (0.5 parts by mass), and the following polymer C (0.1 parts by mass) were dissolved in cyclopentanone (175 parts by mass), methyl ethyl ketone (50 parts by mass), and ethyl laurate (10 parts by mass) used as solvents to prepare a composition 1 for forming a first optically anisotropic layer.

The composition 1 for forming a first optically anisotropic layer was applied onto the previously formed second optically anisotropic layer with a wire bar coater #7 to form a composition layer. The formed composition layer was once heated to 120° C. on a hot plate and cooled to 60° C. so that the alignment was stabilized. Thereafter, using an ultra-high pressure mercury lamp and in a nitrogen atmosphere (oxygen concentration of less than 100 ppm), first ultraviolet irradiation (80 mJ/cm²) was carried out at a film temperature kept at 60° C., and then second ultraviolet irradiation (300 mJ/cm²) was carried out at a film temperature kept at 100° C. to fix the alignment to form a first optically anisotropic layer having a thickness of 2.8 m, thereby producing a retardation layer film 3. The first optically anisotropic layer was a positive A-plate satisfying the expression (A1) of nx>ny≈nz, and corresponded to a so-called λ/4 plate.

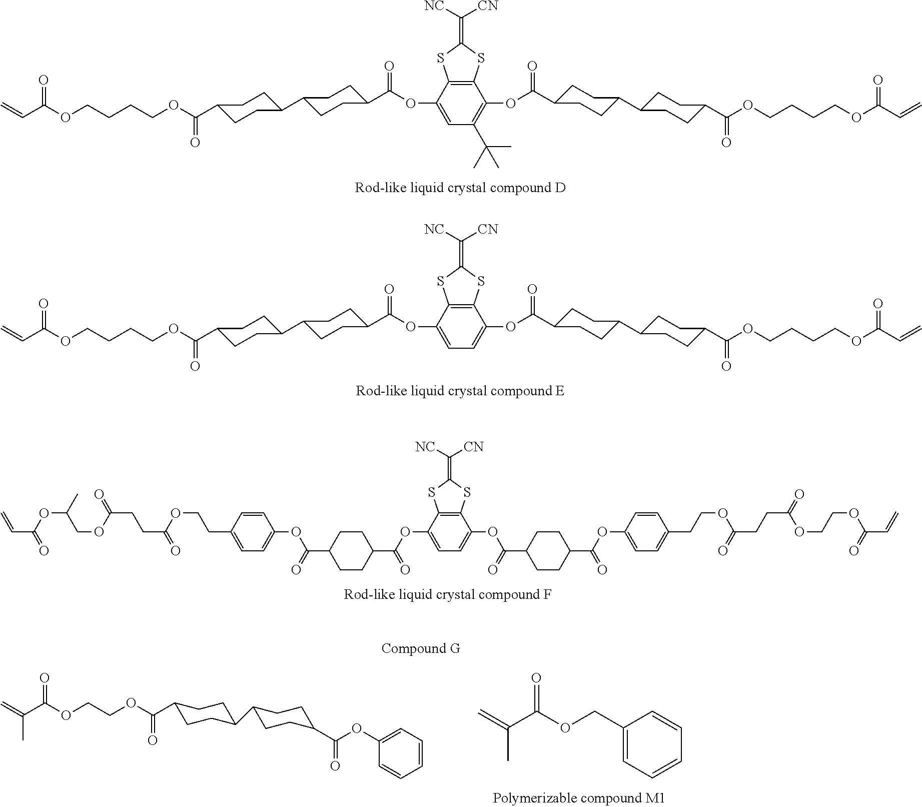

Polymer C (weight-average molecular weight: 25,000)

(in the formula, the numerical value described in each repeating unit denotes the content (% by mass) of each repeating unit with respect to all repeating units)

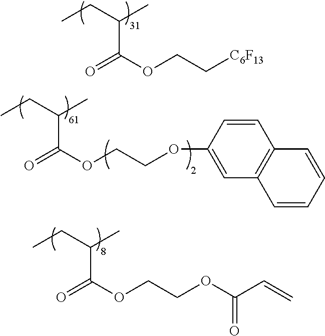

### <Production of Reflective Circular Polarizer Film 1>

### (Coating Liquid R-1 for Reflective Layer)

A composition shown below was stirred in a container held at 70° C. to prepare a coating liquid R-1 for a reflective layer. Here, R represents a coating liquid containing a rod-like liquid crystal compound.

Coating liquid R-1 for reflective layer

| | | |
|---|---|---|
| Methyl ethyl ketone | 120.9 | parts by mass |
| Cyclohexanone | 21.3 | parts by mass |
| Mixture X of rod-like liquid | 100.0 | parts by mass |
| crystal compounds shown below | | |
| Photopolymerization initiator | 1.00 | part by mass |
| B shown below | | |
| Chiral agent A shown below | 4.18 | parts by mass |
| Surfactant F1 shown below | 0.1 | parts by mass |

### Mixture X of Rod-Like Liquid Crystal Compounds

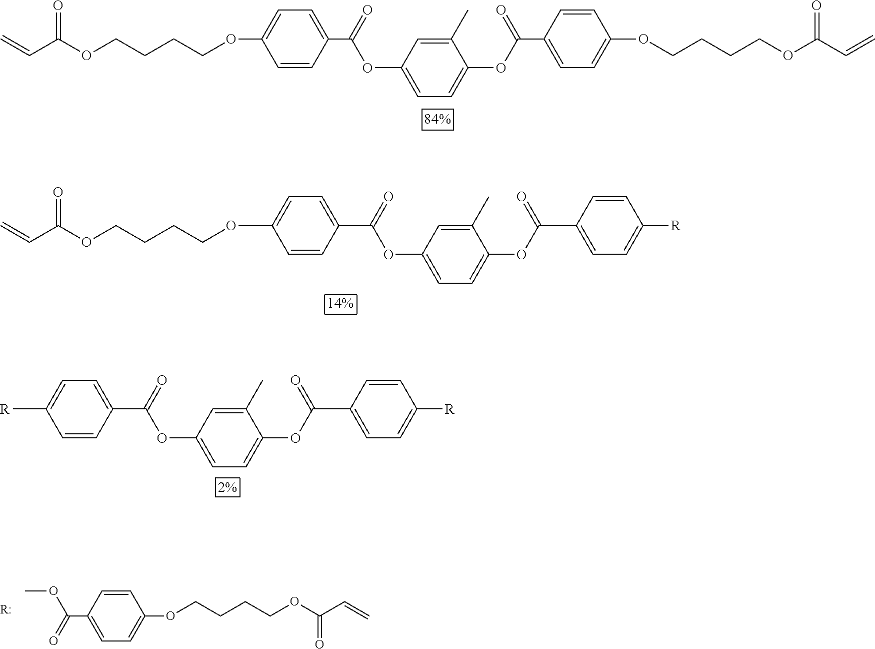

In the above-described mixture X, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol cm.

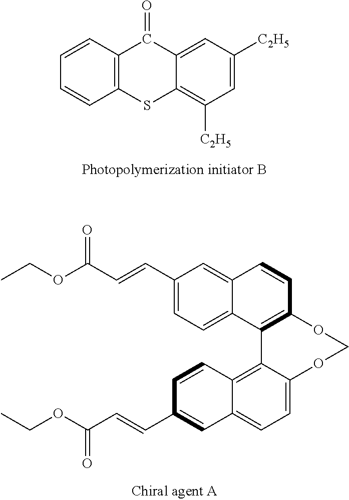

Surfactant F1 (weight-average molecular weight. 25,000)

(the content ratio (mass ratio) between the repeating unit described on the upper side and the repeating unit described on the lower side in the formula was 76:24)

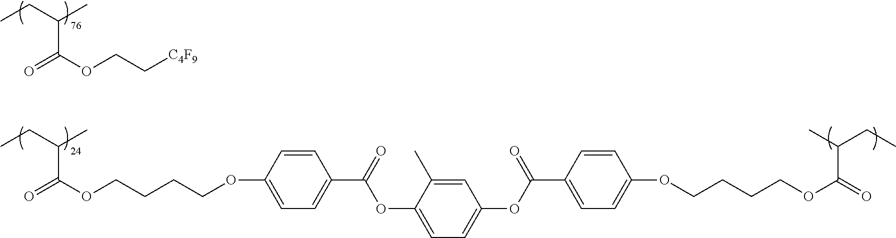

The chiral agent A was a chiral agent in which helical twisting power (HTP) was reduced by light.

### (Coating Liquid R-2 for Reflective Layer)

A coating liquid was prepared in the same manner as in the coating liquid R-1 for a reflective layer, except that the amount of the chiral agent A added was changed as shown in Table 1 below.

Table 1. Amount of chiral agent in coating liquid containing rod-like liquid crystal compound

TABLE 1

| Coating | Amount of chiral agent |
|---|---|
| liquid name | (part by mass) |
| Liquid R-1 | 4.18 |
| Liquid R-2 | 3.40 |

### (Coating Liquid D-1 for Reflective Layer)

A composition shown below was stirred in a container held at 50° C. to prepare a coating liquid D-1 for a reflective layer. Here, D represents a coating liquid containing a disk-like liquid crystal compound.

Coating liquid D-1 for reflective layer

| | | |
|---|---|---|
| Disk-like liquid crystal | 80 | parts by mass |
| compound (A) shown below | | |
| Disk-like liquid crystal | 20 | parts by mass |
| compound (B) shown below | | |
| Polymerizable monomer | 10 | parts by mass |
| E1 shown below | | |
| Surfactant F2 shown below | 0.3 | parts by mass |
| Photopolymerization initiator | 3 | parts by mass |
| (IRGACURE 907 manufactured | | |
| by BASF SE) | | |
| Chiral agent A shown above | 5.45 | parts by mass |
| Methyl ethyl ketone | 290 | parts by mass |
| Cyclohexanone | 50 | parts by mass |

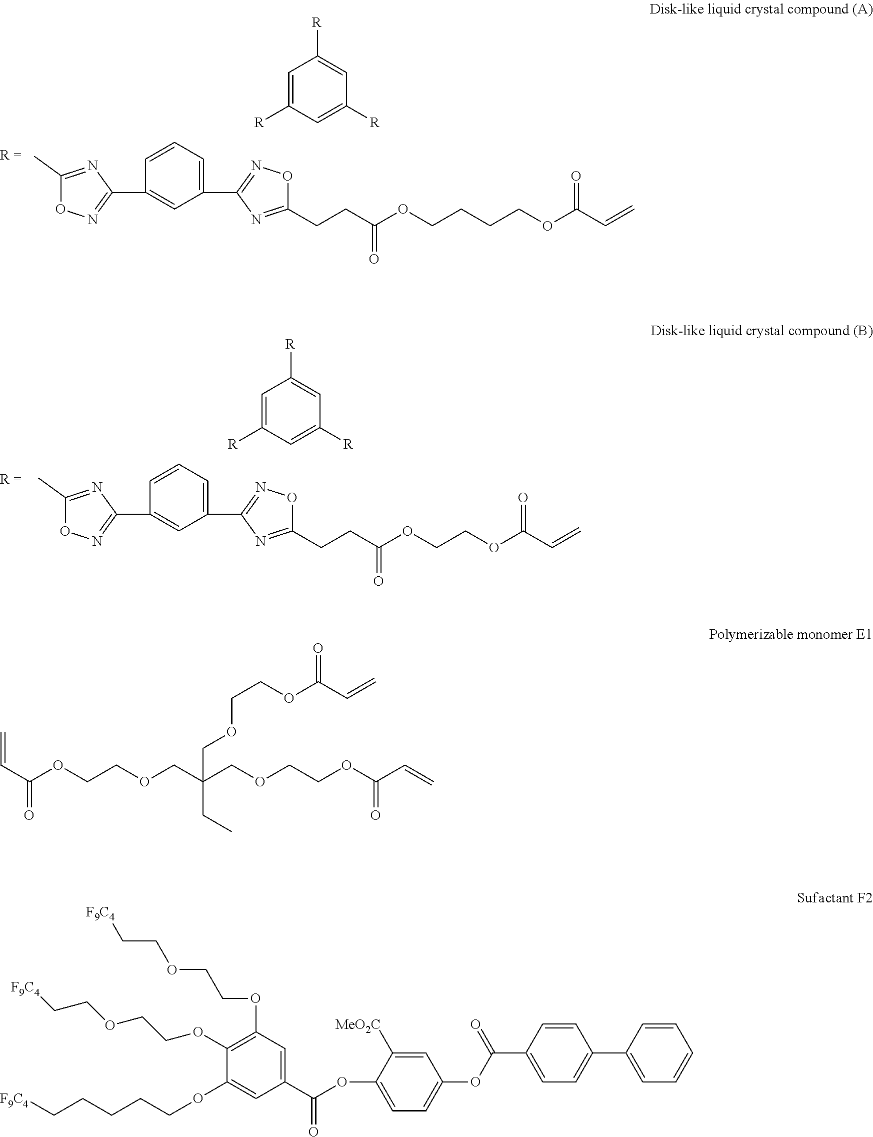

### (Coating Liquids D-2 and D-3 for Reflective Layer)

A coating liquid D-2 for a reflective layer was prepared in the same manner as in the coating liquid D-1 for a reflective layer, except that the amount of the chiral agent A added was changed as shown in Table 2.

Table 2. Amount of chiral agent in coating liquid containing disk-like liquid crystal compound

TABLE 2

| Coating | Amount of chiral agent |
|---|---|
| liquid name | (part by mass) |
| Liquid D-1 | 5.45 |
| Liquid D-2 | 4.52 |
| Liquid D-3 | 4.10 |

### (Coating Liquid PA-1 for Light Interference Layer)

A composition shown below was stirred in a container held at 60° C. to prepare a coating liquid PA-1 for a light interference layer.

Coating liquid PA-1 for light interference layer

| | | |
|---|---|---|
| Methyl isobutyl ketone | 3011.0 | parts by mass |
| Mixture X of rod-like liquid | 100.0 | parts by mass |
| crystal compounds shown above | | |
| Photopolymerization initiator C | 5.1 | parts by mass |
| shown below | | |
| Photoacid generator shown below | 3.0 | parts by mass |
| Hydrophilic polymer shown below | 2.0 | parts by mass |
| Vertical alignment agent shown below | 1.9 | parts by mass |
| Viscosity reducing agent shown below | 4.2 | parts by mass |
| Photo-alignment polymer B shown above | 8.0 | parts by mass |
| Stabilizer shown below | 0.2 | parts by mass |

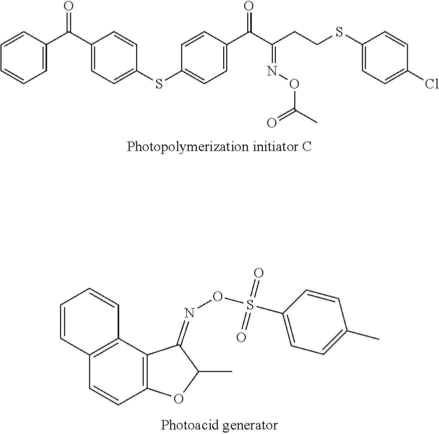 [SMILES: CC(=O)O/N=C(\CCSc1ccc(Cl)cc1)C(=O)c1ccc(Sc2ccc(C(=O)c3ccccc3)cc2)cc1 ; Cc1ccc(S(=O)(=O)O/N=C2/c3c(ccc4ccccc34)OC2C)cc1]

Hydrophilic polymer (weight-average molecular weight: 57,000)

(in the formula, the numerical value described in each repeating unit denotes the content (% by mass) of each repeating unit with respect to all repeating units)

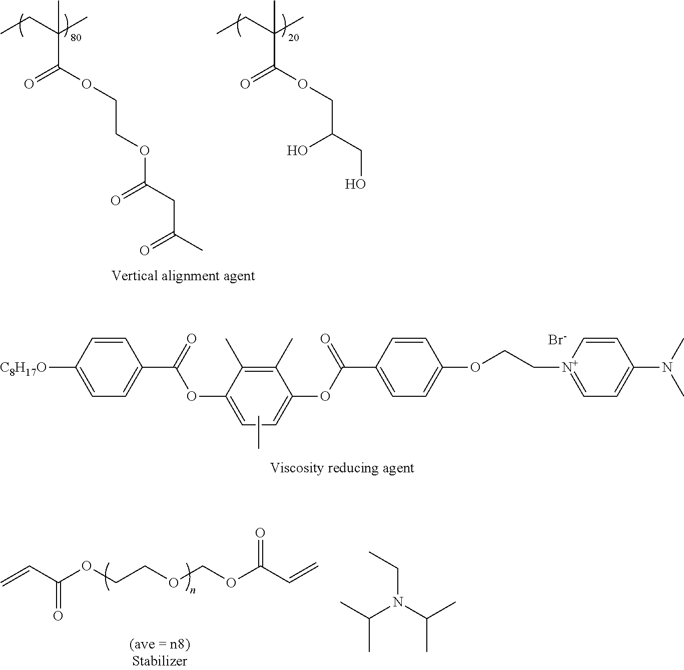

### <Production of Reflective Circular Polarizer>

As a temporary support, a triacetyl cellulose (TAC) film (manufactured by FUJIFILM Corporation, TG60) having a thickness of 60 m was prepared.

The TAC film was coated with the coating liquid PA-1 for a light interference layer prepared above with a wire bar coater, and then dried at 80° C. for 60 seconds. Thereafter, the liquid crystal compound was cured by irradiating with light from an ultraviolet LED lamp (wavelength: 365 nm) with an irradiation amount of 300 mJ/cm² at 78° C. in a low oxygen atmosphere (100 ppm), and at the same time, a cleavage group of the photo-alignment polymer B was cleaved. Thereafter, the liquid crystal compound was heated at 115° C. for 25 seconds to eliminate a substituent containing a fluorine atom. As a result, a positive C-plate having a cinnamoyl group on the outermost surface and having a film thickness of 90 nm was formed. A refractive index nI measured with an interference film thickness meter OPTM (manufactured by Otsuka Electronics Co., Ltd., analyzed by a least squares method) was 1.57. Rth at a wavelength of 550 nm, which was measured with Axoscan (manufactured by Axometrics), was −9 nm.

Next, polarized UV light (wavelength: 313 nm) with an illuminance of 7 mW/cm² and an irradiation amount of 7.9 mJ/cm² was emitted from the positive C-plate side. The polarized UV light having a wavelength of 313 nm was obtained by transmitting ultraviolet light emitted from a mercury lamp through a band-pass filter having a transmission band at a wavelength of 313 nm and a wire grid polarizing plate. The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a blue light reflecting layer consisting of a cholesteric liquid crystal layer. The irradiation with light was performed from the side of the cholesteric liquid crystal layer in all cases. Here, the thickness of the coating was adjusted so that the film thickness of the cured first blue light reflecting layer was 2.6 m.

Next, the surface of the first blue light reflecting layer was subjected to a corona treatment at a discharge amount of 150 W min/m², and the surface subjected to the corona treatment was coated with the coating liquid D-1 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflecting layer on the first blue light reflecting layer. The irradiation with light was performed from the side of the cholesteric liquid crystal layer in all cases. Here, the thickness of the coating was adjusted so that the film thickness of the cured second blue light reflecting layer was 2.0 m.

Next, the second blue light reflecting layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a green light reflecting layer on the second blue light reflecting layer. The irradiation with light was performed from the side of the cholesteric liquid crystal layer in all cases. Here, the coating thickness was adjusted so that the film thickness of the cured green light reflecting layer was 2.7 m.

Next, the green light reflecting layer was coated with the coating liquid R-2 for a reflective layer using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer on the green light reflecting layer. The irradiation with light was performed from the side of the cholesteric liquid crystal layer in all cases. Here, the coating thickness was adjusted so that the film thickness of the cured red light reflecting layer was 3.4 m.

Next, the surface of the red light reflecting layer was subjected to a corona treatment at a discharge amount of 150 W min/m², and the surface subjected to the corona treatment was coated with the coating liquid D-3 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a yellow light reflecting layer on the red light reflecting layer. The irradiation with light was performed from the side of the cholesteric liquid crystal layer in all cases. Here, the coating thickness was adjusted so that the film thickness of the cured yellow light reflecting layer was 3.4 m.

Table 3 shows the reflection center wavelength and the film thickness of each of the reflective layers of the produced reflective circular polarizers. Here, the reflection center wavelength was used to define characteristics of a light reflection film having a reflection band formed of a cholesteric liquid crystal, and referred to the middle point of a spectral band reflected by the film. Specifically, the reflection center wavelength was obtained by calculating the average value of the wavelengths on the short wavelength side and the wavelengths on the long wavelength side which show the half value of the peak reflectivity. A reflection center wavelength (central wavelength of reflected light) was confirmed by producing a film obtained by applying only a single layer. The film thickness was obtained by SEM.

Table 3. Characteristics of light reflecting layer of reflective circular polarizer

TABLE 3

| | | Reflection | Film |
|---|---|---|---|
| | Type of | center | |
| | coating | wavelength | thickness |
| | liquid | (nm) | (μm) |
| Fifth layer | Liquid D-3 | 586 | 3.4 |
| Fourth layer | Liquid R-2 | 661 | 3.4 |
| Third layer | Liquid D-2 | 531 | 2.7 |
| Second layer | Liquid D-1 | 441 | 2.0 |
| First layer | Liquid R-1 | 475 | 2.6 |

### <Production of Moth-Eye Film 1>

With regard to the description in paragraphs [0177] to [0210] of WO2018/180003A, a substrate HC-1 with a hard coat was changed a PMMA film, and bonded with a UV adhesive.

As a result, a moth-eye film 1 having a configuration of moth-eye layer/adhesion layer/PMMA film was obtained.

### <Production of Optical Laminate A0>

An optical laminate A0 was produced by the following procedure. The yellow light reflecting layer side of the obtained reflective circular polarizer film 1 was bonded to a PMMA film (50 μm) with a pressure sensitive adhesive, and the temporary support (TG60) was peeled off. Furthermore, the positive C-plate side of the obtained retardation layer film 2 was bonded to the surface of the PMMA film bonded to the reflective circular polarizer film 1 with a pressure sensitive adhesive, and the support and the alignment layer were peeled off. Furthermore, the positive A-plate side of the obtained retardation layer film 1 was bonded to the exposed liquid crystal surface with a pressure sensitive adhesive, and the alignment film and the support were peeled off. In this manner, an optical laminate A0 including reflective circular polarizer/pressure sensitive adhesion layer/PMMA film/pressure sensitive adhesion layer/positive C-plate/pressure sensitive adhesion layer/positive A-plate was produced.

### <Production of Optical Laminate B0>

An optical laminate B0 was produced by the following procedure. A broadband dielectric multilayer film (trade name: APF, 3M Company) was used as a reflective linear polarizer. The liquid crystal layer side of the retardation layer film 3 was bonded to one surface of the APF with a pressure sensitive adhesive, and the support was peeled off. As a result, an optical laminate B0 including a reflective linear polarizer/pressure-sensitive adhesion layer/positive A plate/positive C plate was produced.

### <Formation of Half Mirror>

A convex surface side of a lens (convex meniscus lens LE1076-A (diameter: 2 inches) manufactured by Thorlabs, Inc.) was subjected to aluminum vapor deposition so that the reflectivity was 40%, thereby forming a half mirror.

### <Production of Composite Lens (1)>

The positive A-plate side of the optical laminate A0 obtained above and the protective layer side of the absorptive polarizer film 1 were bonded to each other with a pressure sensitive adhesive, and only the support of the absorptive polarizer film 1 was peeled off. However, the positive A-plate and the light absorption anisotropic layer were laminated such that a slow axis of the positive A-plate and an absorption axis of the light absorption anisotropic layer formed an angle of 45°.

Next, a pressure sensitive adhesion layer was provided on the reflective circular polarizer side using a pressure sensitive adhesive sheet. As a result, an optical laminate C1 including a pressure-sensitive adhesion layer/reflective circular polarizer/pressure-sensitive adhesion layer/PMMA film/pressure-sensitive adhesion layer/positive C plate/pressure-sensitive adhesion layer/positive A plate/pressure-sensitive adhesion layer/protective layer D1/light absorption anisotropic layer C1 in this order was obtained.

Next, the optical laminate C1 was set in a forming device. In this case, the light absorption anisotropic layer C1 side was disposed on the lower side. The forming space in the forming device consisted of a box 1 and a box 2 partitioned by the optical laminate C1, and a mold 1 (convex lens having a diameter of 50 mm and a curvature radius of 60 mm) was disposed on the box 1 on the lower side of the optical laminate C1 such that the convex surface was on the upper side. In addition, a transparent window was installed on the upper part of the box 2 on the upper side of the optical laminate C1, and an IR light source for heating the optical laminate C1 was installed on the outside of the forming device. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the temperature of the optical laminate C1 reached 108° C. Next, as a step of pressing the optical laminate C1 against the mold 1 to deform the optical laminate C1 along a shape of the mold 1, gas was allowed to flow into the box 2 from a gas cylinder to pressurize the optical laminate C1 to 300 kPa, and the optical laminate C1 was pressed against the mold 1. Finally, the optical laminate C1 was removed from the lens which was the mold 1. As a result, an optical laminate C1 formed into a convex surface shape was obtained.

Next, the optical laminate C1 formed into a convex surface shape was set in the forming device such that the optical laminate C1 was formed in an opposite direction to the first forming with the light absorption anisotropic layer C1 side on the upper side. In this case, the region of the optical laminate C1 formed into a convex surface shape by the first forming protruded on the lower side. A meniscus lens (diameter: 50 mm, curvature radius of concave surface side: 50 mm) on which aluminum vapor deposition was performed on the convex surface side was disposed as a mold 2 such that the concave surface was on the upper side directly below the region of the optical laminate C1 formed into a convex surface shape. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the temperature of the optical laminate C1 reached 108° C. Next, as a step of pressing the optical laminate C1 against the mold 2 to deform the optical laminate C1 along a shape of the mold 2, gas was allowed to flow into the box 2 from a gas cylinder to pressurize the optical laminate C1 to 300 kPa, and the optical laminate C1 was pressed against the mold 2.

As a result, a laminate formed into a curved surface (hereinafter, also referred to as a “composite lens”) was obtained as Example 1.

### Example 2

A composite lens was obtained according to the same procedure as in Example 1, except that the liquid crystal compounds L1 and L2 in the composition C1 for forming a light absorption anisotropic layer were changed to liquid crystal compounds L3 and L4, respectively.

The composition obtained by changing the liquid crystal compounds L1 and L2 in the composition C1 for forming a light absorption anisotropic layer to the liquid crystal compounds L3 and L4, respectively, is defined as a composition C2 for forming a light absorption anisotropic layer.

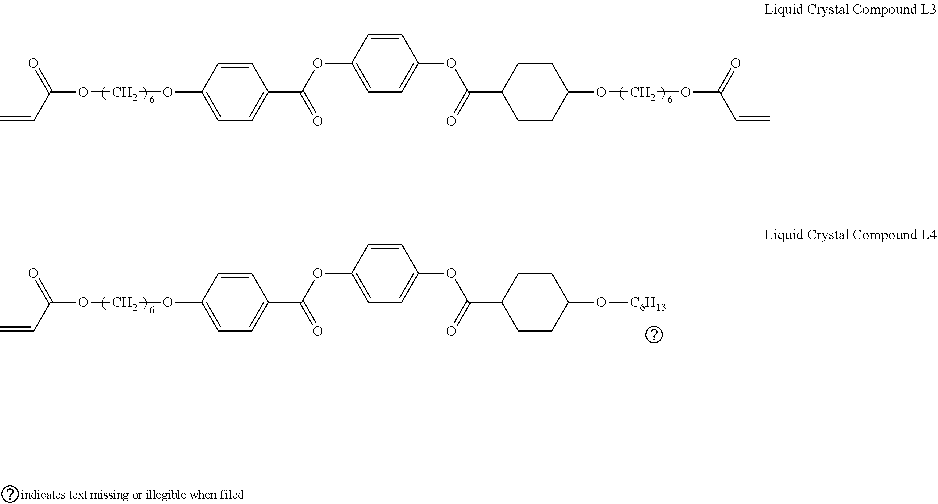

### Example 3

A composite lens was obtained according to the same procedure as in Example 1, except that the composition C1 for forming a light absorption anisotropic layer was changed to a composition C3 for forming a light absorption anisotropic layer.

Composition C3 for forming light absorption anisotropic layer

| | | |
|---|---|---|
| Liquid crystal compound L1 shown above | 73.5 | parts by mass |
| Liquid crystal compound L2 shown above | 24.5 | parts by mass |
| Dichroic substance Al shown above | 3 | parts by mass |
| Dichroic substance A2 shown above | 3 | parts by mass |
| Dichroic substance A3 shown above | 1 | part by mass |
| Dichroic substance A4 shown above | 1 | part by mass |
| Thiol compound T1 shown below | 1.8 | parts by mass |
| 2-Dimethylamino-2-benzyl- | 6 | parts by mass |
| 1-(4-morpholinophenyl) | | |
| butan-1-one (IRGACURE | | |
| manufactured by BASF SE) | | |
| Polyacrylate compound (BYK-361N, | 1.2 | parts by mass |
| manufactured by BYK-Chemie GmbH) | | |
| Laromer (registered trademark) LR-9000 | 2 | parts by mass |
| o-xylene | 250 | parts by mass |

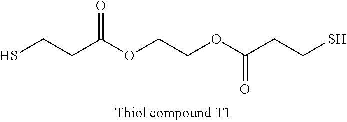 [SMILES: O=C(CCS)OCCOC(=O)CCS]

### Example 4

A composite lens was obtained according to the same procedure as in Example 1, except that <Production of composite lens (1)> was changed to <Production of composite lens (2)> below.

### <Production of Composite Lens (2)>

An optical laminate C1 was produced according to the same procedure as in <Production of composite lens (1)> above.

Next, the optical laminate C1 was set in a forming device. In this case, the light absorption anisotropic layer C1 side was disposed on the upper side. The forming surface in the forming device consisted of a box 1 and a box 2 partitioned by the optical laminate C1, and a meniscus lens (diameter: 40 mm, curvature radius of concave side: 38 mm) on which aluminum was vapor-deposited on the convex side as the mold was disposed in the box 1 located below the optical laminate C1 such that the concave surface was on the upper side. In addition, in the box 2 on the upper side of the light absorption anisotropic layer C1, a transparent window was provided on the upper part, and an IR light source for heating the optical laminate C1 was provided on the outside of the window. Between the IR light source and the optical laminate C1, a cholesteric liquid crystal layer which reflects infrared rays with wavelengths from 2.2 μm to 3.0 μm at a reflectivity of approximately 50% was cut into a circular shape having a diameter of 1 inch, and a circular patterned infrared reflecting filter was disposed. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the center portion of the optical laminate C1 reached 99° C. and the end portion thereof reached 108° C. Next, as a step of pressing the optical laminate C1 against the mold to deform the optical laminate C1 along a shape of the mold, gas was allowed to flow into the box 2 from a gas cylinder to pressurize the optical laminate C1 to 300 kPa, and the optical laminate C1 was pressed against the mold. As a result, a laminate (composite lens) formed into a curved surface was obtained as Example 4.

### Example 5

A composite lens was obtained according to the same procedure as in Example 4, except that the composition C1 for forming a light absorption anisotropic layer was changed to the composition C3 for forming a light absorption anisotropic layer.

### Example 6

A composite lens was obtained according to the same procedure as in Example 4, except that the meniscus lens (diameter: 40 mm, curvature radius of concave surface side: 38 mm) was changed to a meniscus lens (diameter: 50 mm, curvature radius of concave surface side: 70 mm).

### Example 7

A composite lens was obtained according to the same procedure as in Example 6, except that an optical laminate D1 obtained in the subsequent procedure was used instead of the optical laminate C1.

### (Production of Optical Laminate D1)

The APF side of the optical laminate B0 obtained above and the protective layer side of the absorptive polarizer film 1 were bonded to each other with a pressure sensitive adhesive, and only the support of the absorptive polarizer film 1 was peeled off. However, the APF and the light absorption anisotropic layer were laminated such that the transmission axis of the APF and the transmission axis of the light absorption anisotropic layer matched each other. Next, a pressure sensitive adhesion layer was provided on the positive C-plate side using a pressure sensitive adhesive sheet. As a result, an optical laminate D1 including a pressure-sensitive adhesion layer/positive C plate/positive A plate/pressure-sensitive adhesion layer/reflective linear polarizer/pressure-sensitive adhesion layer/protective layer D1/light absorption anisotropic layer C1 was obtained.

### Example 8

A composite lens was obtained according to the same procedure as in Example 7, except that the meniscus lens (diameter: 50 mm, curvature radius of concave surface side: 70 mm) was changed to a meniscus lens (diameter: 50 mm, curvature radius of concave surface side: 78 mm).

### Example 9

A composite lens was obtained according to the same procedure as in Example 8, except that an optical laminate C2 obtained in the subsequent procedure was used instead of the optical laminate D1.

### (Production of Optical Laminate C2)

The positive A plate side of the phase difference layer film 3 was bonded to the optical laminate C1 on the light absorption anisotropic layer C1 side with a pressure-sensitive adhesive, and only the support of the phase difference layer film 3 was peeled off. However, the positive A-plate and the light absorption anisotropic layer C1 were laminated such that a slow axis of the positive A-plate and an absorption axis of the light absorption anisotropic layer formed an angle of 45°. Furthermore, the PMMA film side of the moth-eye film 1 was bonded to the peeling surface with a pressure sensitive adhesive. As a result, an optical laminate C2 including a pressure-sensitive adhesion layer/reflective circular polarizer/pressure-sensitive adhesion layer/PMMA film/pressure-sensitive adhesion layer/positive C plate/pressure-sensitive adhesion layer/positive A plate/pressure-sensitive adhesion layer/protective layer D1/light absorption anisotropic layer C1/pressure-sensitive adhesion layer/positive A plate/positive C plate/pressure-sensitive adhesion layer/PMMA film/UV adhesion layer/moth-eye layer was obtained.

### Example 10

A composite lens was obtained according to the same procedure as in Example 8, except that an optical laminate D2 obtained in the subsequent procedure was used instead of the optical laminate D1.

### (Production of Optical Laminate D2)

The positive A plate side of the phase difference layer film 3 was bonded to the optical laminate D1 on the light absorption anisotropic layer C1 side with a pressure-sensitive adhesive, and only the support of the phase difference layer film 3 was peeled off. However, the positive A-plate and the light absorption anisotropic layer C1 were laminated such that a slow axis of the positive A-plate and an absorption axis of the light absorption anisotropic layer formed an angle of 45°. Furthermore, the PMMA film side of the moth-eye film 1 was bonded to the peeling surface with a pressure sensitive adhesive. As a result, an optical laminate D2 including a pressure-sensitive adhesion layer/positive C plate/positive A plate/pressure-sensitive adhesion layer/reflective linear polarizer/pressure-sensitive adhesion layer/protective layer D1/light absorption anisotropic layer C1/pressure-sensitive adhesion layer/positive A plate/positive C plate/pressure-sensitive adhesion layer/PMMA film/UV adhesion layer/moth-eye layer was obtained.

### Comparative Example 1

The optical laminate C1 was set in a forming device. In this case, the light absorption anisotropic layer C1 side was disposed on the upper side. The forming surface in the forming device consisted of a box 1 and a box 2 partitioned by the optical laminate C1, and a meniscus lens (diameter: 50 mm, curvature radius of concave side: 50 mm) on which aluminum was vapor-deposited on the concave side as the mold 2 was disposed in the box 1 located below the optical laminate C1 such that the concave surface was on the upper side. In addition, a transparent window was installed on the upper part of the box 2 on the upper side of the optical laminate C1, and an IR light source for heating the optical laminate C1 was installed on the outside of the forming device. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the temperature of the optical laminate C1 reached 108° C. Next, as a step of pressing the optical laminate C1 against the mold 2 to deform the optical laminate C1 along a shape of the mold 2, gas was allowed to flow into the box 2 from a gas cylinder to pressurize the optical laminate C1 to 300 kPa, and the optical laminate C1 was pressed against the mold 2. As a result, a laminate (composite lens) formed into a non-planar shape was obtained as Comparative Example 1.

### Comparative Example 2

A substrate (lens) on which a corona treatment was performed on the concave surface side of the meniscus lens was used as a curved surface substrate. The composition B1 for forming a photo-alignment film was applied onto the surface on which the corona treatment was performed using a spin coater, and dried with hot air at 140° C. for 120 seconds, and then the coating film was irradiated with polarized ultraviolet rays (10 mJ/cm², using an ultra-high pressure mercury lamp) to form a photo-alignment film B1. The composition C1 for forming a light absorption anisotropic layer was continuously applied onto the obtained photo-alignment film B1 using a spin coater to form a coating film. The coating film was heated at 110° C. for 120 seconds, and the coating film was rapidly cooled to room temperature (23° C.). Thereafter, the coating film was irradiated with ultraviolet rays at an exposure amount of 1000 mJ/cm² (365 nm basis) using a high-pressure mercury lamp to form a light absorption anisotropic layer C1. The coating liquid D1 for forming a protective layer was continuously applied onto the light absorption anisotropic layer C1 with a spin coater. Thereafter, the coating liquid was dried with hot air at 80° C. for 5 minutes, and irradiated with a light emitting diode (LED) lamp (central wavelength: 365 nm) under an irradiation condition of 300 mJ to form a protective layer D1, thereby obtaining a laminate including a curved surface substrate, a photo-alignment film B1, a light absorption anisotropic layer C1, and the protective layer D1 adjacent to each other in this order, that is, a laminate (composite lens).

### [Evaluation of Formed Absorptive Polarizer Film]

### <Method of Measuring Polarization Degree>

### (Evaluation of Polarization Degree)

A sample (polarization degree measurement sample) in which the protective layer side of the absorptive polarizer film used in Examples 1 to 10 and Comparative Example 1 was bonded to a PMMA film by UV adhesion and only the support of the absorptive polarizer film was peeled off was produced, and the sample was formed under the same conditions as the curved surface forming conditions in each of Examples and Comparative Example to obtain a curved surface formed polarization degree measurement sample X, and the polarization degree was measured using the obtained curved surface formed polarization degree measurement sample. It was confirmed that the obtained curved surface formed polarization degree measurement sample X included a photo-alignment film, a light absorption anisotropic layer, a protective layer, and a PMMA film, but the photo-alignment film, the protective layer, and the PMMA film did not affect the polarization degree. The polarization performance of the light absorption anisotropic layer in the obtained curved surface formed polarization degree measurement sample X was calculated by cutting out a center portion of the polarization degree measurement sample X in a 2 cm square, bonding the cutout portion to FUJITAC TD80UL (manufactured by FUJIFILM Corporation) with a pressure-sensitive adhesive sheet “NCF-D692 (5)” (manufactured by LINTEC Corporation), and using an automatic polarizing film measuring device VAP-7070 (manufactured by JASCO Corporation) to calculate the luminosity sensitivity-corrected polarization degree. The results are shown in Table 4 below.

Here, the “luminosity sensitivity-corrected polarization degree” is a polarization degree in which the transmittance in a wavelength range of 380 to 780 nm incident from the FUJITAC TD80UL side is measured by installing a light source, a linear polarizer, and a curved surface formed absorptive polarizer film for measurement in this order, and the values of the transmittance for every 5 nm in a wavelength range of 380 to 780 nm are weighted and averaged using the Y values of the XYZ color matching function (CIE 1931 standard observer color matching function) standardized by the International Commission on Illumination (CIE). More specifically, a calculated value A which is a product of the transmittance value measured at every 5 nm between 380 and 780 nm and the Y value corresponding to the measurement wavelength of the transmittance was measured for every measurement wavelength, the calculated values A obtained at each measurement wavelength are summed to calculate a total value B, and further, the obtained total value B is divided by a total value C of the Y values used above (the total value B/the total value C) to calculate a transmittance.

In the measurement of the transmittance, linearly polarized light parallel to the transmission axis of the light absorption anisotropic layer is emitted from the normal direction of the surface of the measurement sample to measure a transmittance T1, linearly polarized light parallel to the absorption axis of the light absorption anisotropic layer is further emitted to measure a transmittance T2, and the polarization degree P1 is calculated from the following expression.

$$Polarization degree [ \% ] = [ ( T 1 - T 2 ) / ( T 1 + T 2 ) ] \times 100$$

T1: transmittance of the light absorption anisotropic layer with respect to polarization in the transmission axis direction
T2: transmittance of the light absorption anisotropic layer with respect to polarization in the absorption axis direction

In the above-described measurement, the polarization degree calculated without using an integrating sphere (detector) (manufactured by JASCO Corporation) was defined as a polarization degree P1, and the polarization degree calculated using an integrating sphere (detector) (manufactured by JASCO Corporation) was defined as a polarization degree P2.

In a case of using the integrating sphere, the distance between the integrating sphere and the measurement sample fixed to the stage was 5 mm.

### [Thickness Measurement]

The in-plane variation in film thickness of the light absorption anisotropic layer in the composite lens produced according to the procedure described in Examples 1 to 10 and Comparative Examples 1 and 2 was measured and evaluated according to the following standard.
A: in-plane variation of the film thickness was less than 4%.
B: in-plane variation of the film thickness was 4% or more and less than 7%.
C: in-plane variation of the film thickness was 7% or more.

The in-plane variation of the film thickness was measured by the above-described method. More specifically, the film thicknesses of 16 points of the light absorption anisotropic layer were calculated according to the above-described procedure, and the in-plane variation was calculated using the values (see FIG. 4).

### [Adhesion Evaluation]

On the center portion of the surface of the composite lens on the light absorption anisotropic layer side, which was produced according to the procedure described in Examples 1 to 10 and Comparative Examples 1 and 2, 6 vertical cuts and 6 horizontal cuts (1 mm width) were made in a grid pattern with a cutter knife, a total of 25 square grids were made, a CT-18 tape (product manufactured by NICHIBAN CO., LTD.) was attached to the surface, and the tape was quickly peeled off in the vertical direction to evaluate the adhesiveness of the light absorption anisotropic layer. The number of peeled grids was counted and evaluated according to the following standard.
A: peeling was observed in 0 to 12 grids in 25 grids.
B: peeling was observed in 13 or more grids.

### [Production of Virtual Reality Display Apparatus]

A virtual reality display apparatus “Huawei VR Glass” manufactured by Huawei Technologies Co., Ltd., which was a virtual reality display apparatus for which a reciprocating optical system was employed, was disassembled, and all composite lenses were taken out. Instead, the composite lens produced in each of Examples and Comparative Examples was incorporated into the main body, and the composite lens was installed such that the light absorption anisotropic layer side of the laminated optical body was on the eye side between the composite lens and the eye, thereby producing a virtual reality display apparatus of Example.

### (Evaluation Method)

In the produced virtual reality display apparatus (Fr product), a gray image was displayed on the center portion of the image display panel, and the tint of the center portion was visually recognized under the same conditions for the virtual reality display apparatus (time-varying product) produced by the method described later, and evaluated in the following three stages by visual observation.

### <Evaluation of Tint>

A: tint is gray
B: a weak color is visible, but it is almost gray
C: a color deviated from gray is visible.

### [Time-Course Evaluation Method]

The produced virtual reality display apparatus (Fr product) was set in a high temperature and high humidity chamber and stored for 1000 hours under conditions of 45° C. and 40%.

In the light absorption anisotropic layer produced in each of Examples, a Bragg peak (peak derived from Bragg reflection) was observed at 20=180 to 220 near by X-ray diffraction measurement.

In Table 4, the column of “Composition formulation” represents the type of the liquid crystal composition used, “Composition 1” means the composition C1 for forming a light absorption anisotropic layer, “Composition 2” means the composition C2 for forming a light absorption anisotropic layer, and “Composition 3” means the composition C3 for forming a light absorption anisotropic layer.

In Table 4, the column of “Curved surface radius” represents the curvature radius of the laminate having a curved surface shape.

In Table 4, the column of “P1” shows the value of the polarization degree P1.

In Table 4, the column of “AP” represents the polarization degree P1−polarization degree P2, “A” means that the polarization degree P1−polarization degree P2 is 0.15% or less, “B” means that the polarization degree P1−polarization degree P2 is more than 0.15% and 0.27% or less, and “C” means that the polarization degree P1−polarization degree P2 is more than 0.27%.

In Table 4, the column of “In-plane film thickness variation” shows the result of the thickness measurement.

In the column of “Configuration” in Table 4, “A1” indicates that the laminate included light absorption anisotropic layer/positive A-plate/positive C-plate/cholesteric liquid crystal layer; “B1” indicates that the laminate included light absorption anisotropic layer/reflective linear polarizer/positive A-plate/positive C-plate; “B2” indicates that the laminate included moth-eye layer/positive A-plate/light absorption anisotropic layer/reflective linear polarizer/positive A-plate/positive C-plate; and “A2” indicates that the laminate included moth-eye layer/QWP layer/light absorption anisotropic layer/positive A-plate/positive C-plate/cholesteric liquid crystal layer.

In Table 4, “Forming condition 1” in the column of “Forming conditions” means that the light absorption anisotropic layer was produced by the above-described method 1, and “Forming condition 2” means that the light absorption anisotropic layer was produced by the above-described method 2.

TABLE 4

| | Light absorption anisotropic layer | | | | | | | | | |
|---|---|---|---|---|---|---|---|---|---|---|
| | | | | | | In-plane | | | | |
| | | Curved | | | | film | | | Evaluation | |
| | Composition | surface | Lens | | | thickness | | Forming | Tint | |
| | formulation | radius | diameter | P1 | ΔP | variation | Configuration | condition | change | Adhesion |
| Example1 | Composition 1 | 50 mm | 50 mm | 97.2% | B | A | A1 | Forming | B | A |
| | | | | | | | | condition 1 | | |
| Example2 | Composition 2 | 50 mm | 50 mm | 97.3% | B | A | A1 | Forming | B | A |
| | | | | | | | | condition 1 | | |
| Example3 | Composition 3 | 50 mm | 50 mm | 97.2% | A | A | A1 | Forming | A | A |
| | | | | | | | | condition 1 | | |
| Example4 | Composition 1 | 38 mm | 40 mm | 97.3% | A | A | A1 | Forming | A | A |
| | | | | | | | | condition 2 | | |
| Example5 | Composition 3 | 38 mm | 40 mm | 97.2% | A | A | A1 | Forming | A | A |
| | | | | | | | | condition 2 | | |
| Example6 | Composition 1 | 70 mm | 50 mm | 97.3% | A | A | A1 | Forming | A | A |
| | | | | | | | | condition 2 | | |
| Example7 | Composition 1 | 70 mm | 50 mm | 97.2% | A | A | B1 | Forming | A | A |
| | | | | | | | | condition 2 | | |
| Example8 | Composition 1 | 78 mm | 50 mm | 97.3% | A | A | B1 | Forming | A | A |
| | | | | | | | | condition 2 | | |
| Example9 | Composition 1 | 78 mm | 50 mm | 97.3% | A | A | A2 | Forming | A | A |
| | | | | | | | | condition 2 | | |
| Example10 | Composition 1 | 78 mm | 50 mm | 97.2% | A | A | B2 | Forming | A | A |
| | | | | | | | | condition 2 | | |
| Comparative | Composition 1 | 50 mm | 50 mm | 97.3% | C | C | A1 | — | C | A |
| Example1 | | | | | | | | | | |
| Comparative | Composition 1 | 50 mm | 50 mm | — | — | B | — | — | — | B |
| Example2 | | | | | | | | | | |

As shown in Table 4, it was confirmed that the present invention exhibited a desired effect.

Among these, it was confirmed that more excellent effects were obtained in a case where the above-described AP was 0.15% (in a case where the above-described AP was “A”).

### EXPLANATION OF REFERENCES

10: laminate
12: substrate
14: pressure-sensitive adhesion layer
16: light absorption anisotropic layer
20: forming die having concave forming surface
22: film
24: film on which concave surface shape is transferred
26, 30: forming die having convex forming surface
28: film on which convex surface shape is transferred
32: precursor film in which convex surface shape is transferred
34, 40: substrate having concave forming surface
36: laminate
42: planar precursor film
50A, 50B: laminate
52: half mirror
54: substrate
56: pressure-sensitive adhesion layer
58: cholesteric liquid crystal layer
60: positive C-plate
62: retardation layer having function of converting linearly polarized light into circularly polarized light
64: light absorption anisotropic layer
66: reflective linear polarizer
80: virtual reality display apparatus
82: image display panel
84: circularly polarizing plate

What is claimed is:

1. A laminate comprising, in the following order:
a substrate;
a pressure-sensitive adhesion layer or an adhesion layer; and
a light absorption anisotropic layer,
wherein the light absorption anisotropic layer contains a liquid crystal compound having smectic liquid crystallinity,
the laminate has a curved surface shape portion, and
the light absorption anisotropic layer in the curved surface shape portion satisfies Requirement X,
Requirement X: in a case where a polarization degree of the light absorption anisotropic layer measured without using an integrating sphere is set as a polarization degree P1, and a polarization degree of the light absorption anisotropic layer measured using an integrating sphere is set as a polarization degree P2, the polarization degree P1 and the polarization degree P2 satisfy a relationship of Expression (1),
$$Polarization degree P 1 - Polarization degree P 2 \leq 0.27 \% . \qquad Expression ( 1 )$$

2. The laminate according to claim 1,
wherein the light absorption anisotropic layer in the curved surface shape portion satisfies Requirement Y,
Requirement Y: the polarization degree P1 and the polarization degree P2 satisfy a relationship of Expression (2),
$$Polarization degree P 1 - Polarization degree P 2 \leq 0.15 \% . \qquad Expression ( 2 )$$

3. The laminate according to claim 1,
wherein the light absorption anisotropic layer contains a dichroic substance.

4. The laminate according to claim 3,
wherein a concentration of the dichroic substance in the light absorption anisotropic layer is 180 mg/cm³ or less.

5. The laminate according to claim 3,
wherein the dichroic substance includes at least two or more dichroic coloring agents having a maximal absorption wavelength of 550 nm or more.

6. The laminate according to claim 1,
wherein the light absorption anisotropic layer exhibits a Bragg peak in X-ray diffraction measurement.

7. The laminate according to claim 1,
wherein an in-plane variation in film thickness of the light absorption anisotropic layer in the curved surface shape portion is less than 7%.

8. The laminate according to claim 1,
wherein the light absorption anisotropic layer is a layer formed of a composition containing a dichroic substance and the liquid crystal compound.

9. The laminate according to claim 8,
wherein the composition contains a thiol compound.

10. The laminate according to claim 8,
wherein the composition contains a compound having an active hydrogen reactive group.

11. The laminate according to claim 1, further comprising:
an alignment film adjacent to the light absorption anisotropic layer.

12. The laminate according to claim 11,
wherein the alignment film is a layer formed of a composition containing a compound having an active hydrogen reactive group.

13. The laminate according to claim 12,
wherein the composition contains a polymer containing a structural unit having a photoreactive group and a structural unit having a polymerizable group.

14. The laminate according to claim 1, further comprising:
a phase difference layer; and
a reflective linear polarizer.

15. The laminate according to claim 1, further comprising:
a cholesteric liquid crystal layer.

16. The laminate according to claim 1, further comprising:
a half mirror.

17. A virtual reality display apparatus comprising:
the laminate according to claim 1.

18. A manufacturing method of the laminate according to claim 1, comprising:
a step 1 of deforming, along a first forming surface, a planar precursor film including a light absorption anisotropic layer and a pressure-sensitive adhesion layer or an adhesion layer by using a forming die having the first forming surface, with a surface on a light absorption anisotropic layer side being on a first forming surface side; and
a step 2 of manufacturing the laminate by deforming, along a second forming surface, a precursor film that is obtained in the step 1 and on which a shape of the first forming surface is transferred, by using a substrate that has the second forming surface having a curvature radius smaller than a curvature radius of the first forming surface, with a surface on a side opposite to a surface in contact with the forming die of the first forming surface of the precursor film being on a side of the second forming surface,
wherein the first forming surface has a concave shape and the second forming surface has a convex shape, or
the first forming surface has a convex shape and the second forming surface has a concave shape.

19. A manufacturing method of the laminate according to claim 1, comprising:
a step of manufacturing the laminate by providing a temperature distribution in an in-plane direction of a planar precursor film including a light absorption anisotropic layer and a pressure-sensitive adhesion layer or an adhesion layer, and by deforming, along a forming surface of a substrate, the precursor film, with a surface of the precursor film on a side opposite to a light absorption anisotropic layer side being on a forming surface side of the substrate that has a forming surface having a curved surface shape.

20. The laminate according to claim 2,
wherein the light absorption anisotropic layer contains a dichroic substance.
